(19) United States
(12) Patent Application Publication
(10) Pub. No.: US 2025/0216124 A1
(43) Pub. Date: Jul. 3, 2025

(54) SYSTEMS, DEVICES AND METHODS OF CONTROLLING A TEMPERATURE OF OIL AND GAS INDUSTRY INFRASTRUCTURE

(71) Applicant: Joseph S. Wroblewski, St. John's (CA)

(72) Inventor: Joseph S. Wroblewski, St. John's (CA)

(21) Appl. No.: 18/999,675

(22) Filed: Dec. 23, 2024

Related U.S. Application Data
(60) Provisional application No. 63/615,092, filed on Dec. 27, 2023.

(51) Int. Cl. F24T 10/17

(52) U.S. Cl. CPC F24T 10/17

(57) ABSTRACT

Closed loop hydronic systems, devices and methods to control a temperature of a petroleum are described herein. The closed loop hydronic systems use a body of water as a heat sink and, optionally, a heat source to control a temperature of the petroleum. The systems include at least one heat exchanger positioned within the body of water. Water is pumped through pipes connected to the heat exchanger(s) to a surface where a vessel, such as but not limited to a transfer pipe or a storage tank, holding the petroleum is present. In one example, the systems may provide a heat sink to cool petroleum in tanks during extreme hot weather conditions. In another example, the systems may provide a heat source to warm marine fuel in tanks during extreme cold weather conditions.

### RELATED APPLICATIONS

The present application claims the benefit of U.S. Provisional Patent application No. 63/615,092 entitled “Systems, Devices and Methods of Controlling a Temperature of Oil and Gas Industry Infrastructure” filed on Dec. 28, 2023, the entire contents of where are hereby incorporated by reference herein in their entirety.

### FIELD

This disclosure relates generally to systems, devices and methods of controlling a temperature, and more specifically to systems, devices and methods of controlling a temperature of infrastructure existing in an oil and gas industry setting.

### BACKGROUND

The invention is a clean technology to enhance the climate resilience of oil and gas industry operations. The invention is novel in that it can both warm and cool existing oil and gas industry infrastructure. Severe hot weather events (e.g., summer heat waves) are becoming commonplace with global warming. Unusual cold weather events are also occurring. The invention is an “add-on” to existing infrastructure in upstream, midstream and downstream industry operations. The operation of the invented technology is low-carbon. The warming/cooling system requires no energy input, other than the electricity needed to pump freshwater through the hydronic system.

The fugitive emission of methane significantly contributes to anthropogenic climate change. The fugitive emission of volatile organic compounds (VOCs) are air pollutants that significantly impact human health. The systems, devices and methods described herein aim to reduce methane emissions and contributes to efforts to slow climate change. The systems, devices and methods described herein may also reduce long term air pollution by VOCs.

There are companies in the U.S., Canada, and the European Union that manufacture methane mitigation equipment and/or offer services. However, these are only infrastructure maintenance efforts to detect and stop methane gas leaks through seals and valves in pipelines.

Within the past decade the environmental issue of anthropogenic climate change has many countries in the world placing new regulations upon industry concerning emission of greenhouse gases (GHGs). Current technology to reduce fugitive emissions of methane and VOCs from crude oil storage tanks is insufficient. A problem on this global scale (i.e. thousands of storage tanks around the world) requires a relatively simple and inexpensive technological solution.

The systems, devices and methods described herein offer a simple operation of cooling the crude oil stored in land-based tanks that may exponentially reduce fugitive emission of methane and VOCs, and can be scaled up to any number of storage tanks at a tank farm.

The systems, devices and methods described herein may also offer assurance of flow in pipelines transporting crude oil, raw natural gas and refinery distillates such as diesel and marine fuel at very cold ambient air temperatures.

Maintaining fluid flow though pipelines is a continual challenge that petroleum engineers face. Methane clathrates (also called hydrates) commonly form during natural gas production operations when water is condensed in the presence of methane under pressure. Once formed, ice-like hydrates can block pipelines (especially at pipe elbows) and oil-gas-water separation equipment. By warming, the systems, devices and methods described herein may inhibit the formation of hydrate plugs inside gathering pipelines carrying raw (untreated) natural gas, assuring continual flow through the lines.

Viscosity and wax content are properties of crude oil important to its flow through pipelines. Heavy crude oil contains dissolved paraffin waxes that can precipitate under certain ambient environmental conditions. The precipitate can form a wax coating on the inside walls of pipelines. A buildup of wax coating can restrict flow through the pipeline, affecting crude oil production operations. By warming, the systems, devices and methods described herein may inhibit the forming of a wax coating inside a pipeline carrying heavy crude oil. The result is maintenance of flow of the heavy crude through pipelines.

Oil viscosity is the measure of the oil's resistance to flow. The viscosity of crude in pipelines depends on the oil's temperature and hydrocarbon composition. When crude is pumped through a pipeline, a pressure difference between the two ends of the pipeline is needed to sustain the flow. The needed pump pressure is proportional to the oil's viscosity. The systems, devices and methods described herein may be used to warm heavy and extra-heavy crude oil, maintaining its viscosity and its flow through existing industry pipelines during cold weather conditions. If not warmed, cold ambient temperatures would increase the viscosity and the force of pumping would need to be increased.

Heavier alkanes within raw natural gas extracted from gas wells will condense to a liquid state if the temperature and pressure of the gas is dropped to atmospheric conditions. The condensed hydrocarbons can form liquid condensate slugs that can affect pumping operations. The condensate is flammable and explosive. Pipeline crews working in areas where volatile condensate has escaped a leaking pipeline can become asphyxiated. The systems, devices and methods described herein may, by warming, inhibit the formation of liquid condensate slugs inside a pipeline carrying raw (untreated) natural gas.

Extreme cold weather can result in the freezing of water inside a pipeline carrying industry produced water. There is then a risk of ice plugging a flow line or valve. Natural gas always has some water content that could freeze. Diesel fuel and marine fuels can gel during extreme winter temperature conditions and no longer be pumped through a refueling pipeline. The systems, devices and methods described herein may, by warming, maintain pipeline operations during cold weather events.

Explosion hazards exist at downstream crude oil processing facilities and natural gas processing facilities worldwide. Catastrophic fires at oil refineries and petrochemical plants have occurred in the past and are still occurring. These accidental fires are costly to the industry and subject local communities to smoke and toxic gases. The systems, devices and methods described herein offer a simple operation of cooling volatile hydrocarbons stored in land-based tanks. Further, the systems, devices and methods described may reduce the risk of explosion and fires at storage tanks near oil refineries and petrochemical plants. The systems, devices and methods described herein may add to firefighting capabilities at refinery distillate storage tank farms and at petrochemical storage tank farms, and/or may also be used to supplement the local water supply for making firefighting foam.

World oil supply is approximately 100 million barrels per day and about half of the world's oil production is moved by tankers on maritime routes. Many millions of barrels of crude oil are stored in land-based tanks until the crude can be processed by refineries. Crude oil inventories in the U.S. are about 400 million barrels and many oil refineries are located along U.S. coastlines. Distillate stockpiles in the U.S. are about 100 million barrels.

The extreme hot weather conditions at low latitude refineries and petrochemical transfer facilities greatly increase the risk of explosion and fire. Heat wave events that are occurring with anthropogenic global warming greatly increase fugitive emissions from stored crude oil. Tanks storing flammable distillates always risk explosion and fire. In the event that a fire or explosion occurs, smoke plumes can drift over populated areas. For example, a petrochemical fire at the Intercontinental Terminal Company (ITC) in Deer Park, Texas during March 2019 spread between fixed-roof tanks storing toluene, naphtha and xylene. Air quality readings downwind of the fire detected fine particulate matter and volatile organic compounds. Fire crews extinguished the blaze four days after it started. The initial fire started when a leak from a tank containing volatile naphtha ignited.

The U.S. Coast Guard halted tanker traffic through a portion of the Houston Ship Channel to prevent transiting ships from spreading the runoff from the ITC chemical fire. The closure due to the tank farm fire cost the local petrochemical industry an estimated $1 billion USD in direct and indirect costs and lost revenues. The Houston Ship channel closure for four days affected container terminals and container cargo ships.

Further, there is a history of industry explosions and fires near Houston, Texas. Industry fires have occurred in other U.S. States and in Canadian Provinces.

In November 2019 residents of Port Neches, Texas living with a four-mile radius of the TPC Group chemical plant were evacuated when two explosions occurred setting fire to three tanks holding butadiene, which is used to make synthetic rubber and plastics. Butadiene is extremely flammable, where gas and air mixture is explosive. Butadiene is a health hazard. Pipes at the plant were covered with asbestos that was expelled into the air by the explosions. Three injured plant workers were likely exposed to butadiene, asbestos and benzene by the smoke plume.

At refineries and petrochemical plants, the tanks storing flammable products can be cooled to reduce vapor pressure and lower the risk of explosion and fire.

Accordingly, there is a need for new systems for cooling storage tanks holding flammable products that could limit flammable clouds and make operations safer by reducing a risk of explosion.

### SUMMARY

In accordance with a broad aspect, a closed loop, hydronic system configured to control a temperature of a petroleum at an upstream petroleum production facility is described herein. The system includes a first heat exchanger submerged in a body of water at a first depth and hydronic pipeline infrastructure fluidly connected to the first heat exchanger and positioned along and adjacent to at least a portion of a vessel containing the petroleum. The hydronic pipeline infrastructure is configured to receive fluid from the first heat exchanger, the fluid being at a first temperature that is below an initial temperature of the petroleum, the fluid within the hydronic pipeline infrastructure receiving heat from the petroleum as the fluid within the hydronic pipeline infrastructure passes by the petroleum to reduce a temperature of the petroleum.

In at least one embodiment, the system includes a second heat exchanger submerged in the body of water at a second depth. The hydronic pipeline infrastructure is also fluidly connected to the second heat exchanger. The hydronic pipeline infrastructure is configured to receive fluid from the second heat exchanger at a second temperature that is above the initial temperature of the petroleum. The fluid within the hydronic pipeline infrastructure provides heat from the fluid to the petroleum as the fluid within the hydronic pipeline infrastructure passes by the petroleum.

In at least one embodiment, the vessel is a crude oil transfer pipe and the petroleum is crude oil.

In at least one embodiment, the vessel is a raw natural gas transfer pipe and the petroleum is natural gas.

In at least one embodiment, the vessel is a well extracting natural gas and the petroleum is the natural gas.

In at least one embodiment, the vessel is a storage tank and the petroleum is natural gas.

In at least one embodiment, the vessel is a storage tank and the petroleum is crude oil.

In at least one embodiment, the hydronic pipeline infrastructure surrounds the vessel.

In at least one embodiment, the system includes a covering configured to surround the hydronic pipeline infrastructure and the vessel.

In accordance with a broad aspect, a closed loop, hydronic system configured to control a temperature of a petroleum at a midstream distribution terminal or transfer facility is described herein. The system includes a first heat exchanger submerged in a body of water at a first depth and hydronic pipeline infrastructure fluidly connected to the first heat exchanger and positioned along and adjacent to at least a portion of a vessel containing the petroleum. The hydronic pipeline infrastructure is configured to receive fluid from the first heat exchanger. The fluid is at a first temperature that is below an initial temperature of the petroleum. The fluid within the hydronic pipeline infrastructure receives heat from the petroleum as the fluid within the hydronic pipeline infrastructure passes by the petroleum to reduce a temperature of the petroleum.

In at least one embodiment, the system also includes a second heat exchanger submerged in the body of water at a second depth. The hydronic pipeline infrastructure is fluidly connected to the second heat exchanger. The hydronic pipeline infrastructure is configured to receive fluid from the second heat exchanger at a second temperature that is above the initial temperature of the petroleum. The fluid within the hydronic pipeline infrastructure provides heat from the fluid to the petroleum as the fluid within the hydronic pipeline infrastructure passes by the petroleum.

In at least one embodiment, the vessel is a storage tank and the petroleum is heavy crude oil or extra heavy crude oil.

In at least one embodiment, the vessel is a transfer pipe and the petroleum is heavy crude oil or extra heavy crude oil.

In at least one embodiment, the hydronic pipeline infrastructure surrounds the vessel.

In at least one embodiment, the system also includes a covering configured to surround the hydronic pipeline infrastructure and the vessel.

In accordance with a broad aspect, a closed loop, hydronic system configured to control a temperature of flammable petroleum products produced at refineries and stored in tank farms is described herein. The system includes a first heat exchanger submerged in a body of water at a first depth and hydronic pipeline infrastructure fluidly connected to the first heat exchanger and positioned along and adjacent to at least a portion of a vessel containing the petroleum. The hydronic pipeline infrastructure is configured to receive fluid from the first heat exchanger. The fluid is at a first temperature that is below an initial temperature of the petroleum. The fluid within the hydronic pipeline infrastructure receives heat from the petroleum as the fluid within the hydronic pipeline infrastructure passes by the petroleum to reduce a temperature of the petroleum.

In at least one embodiment, the hydronic pipeline infrastructure cools flammable distillate pumped into the vessel, reducing vapor pressure in the top of the vessel, thereby limiting explosive vapor cloud.

In at least one embodiment, the vessel is a storage tank and the petroleum is naphtha.

In at least one embodiment, the hydronic pipeline infrastructure surrounds the vessel.

In at least one embodiment, the system also includes a water tower configured to store freshwater and supply pressured freshwater to the hydronic pipeline infrastructure.

In accordance with a broad aspect, a hydronic system to cool crude oil with volatile hydrocarbons such as methane and benzene in land-based storage tanks, the system comprising cooling pipeline infrastructure carrying freshwater positioned alongside the storage tanks is described herein.

In accordance with a broad aspect, a hydronic system to warm gathering pipelines at onshore wells producing raw natural gas with hydrates, the system comprising warming pipeline infrastructure carrying freshwater positioned alongside the gathering pipelines is described herein.

In accordance with a broad aspect, a hydronic system to warm gathering pipelines at onshore wells producing heavy crude oil with paraffin waxes, the system comprising warming pipeline infrastructure carrying freshwater positioned alongside the gathering pipelines is described herein.

In accordance with a broad aspect, a hydronic system to reduce viscosity of heavy and extra-heavy crude oil pumped through pipelines, the system comprising warming pipeline infrastructure carrying freshwater positioned alongside the pipelines is described herein.

In accordance with a broad aspect, a hydronic system to warm gathering pipelines at onshore wells producing raw natural gas with condensate, the system comprising warming pipeline infrastructure carrying freshwater positioned alongside the gathering pipelines is described herein.

In accordance with a broad aspect, a hydronic system to warm one or more components upstream at a crude oil production facility or raw natural gas production facility where winter weather increases a risk of pipeline blockage by ice, the system comprising warming pipeline infrastructure carrying freshwater positioned alongside the one or more components at the crude oil production facility or natural gas production facility is described herein.

In accordance with a broad aspect, a hydronic system installed at an oil refinery or petrochemical plant that produces and stores a volatile distillate or petrochemical, the system comprising pipeline infrastructure carrying freshwater to cool the flammable product stored in tanks is described herein.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a diagram of a hydronic system according to at least one embodiment described herein having a freshwater source, having a pipeline and freshwater intake to the hydronic system. The freshwater that initially fills the hydronic system is supplied by a local freshwater source, e.g., a reservoir, river, lake or pond. The freshwater source may or may not be the deep-water body used by the hydronic system for warming/cooling industry pipelines on the industry site.

FIGS. 2A and 2B show perspective and end views, respectively, of one example of a closed-loop hydronic system described herein including hydronic piping placed over and parallel to the existing industry pipelines, but not touching so as to avoid abrasion of the existing pipelines.

FIG. 2C shows one example of a concentric tube arrangement where the closed-loop hydronic system piping encloses the existing industry pipeline. Here the hydronic fluid is in direct contact with the industry pipeline wall.

FIG. 3A is a diagram showing placement of heat exchangers of a hydronic system according to at least one embodiment described herein in a deep-water body (the freshwater source, or otherwise a reservoir, lake, river or coastal sea) near the industry site.

FIG. 3B shows one example of a heat exchanger immersed in a deep-water body for use with the hydronic systems described herein.

FIG. 4A is a diagram showing the hydronic system applied at a marine transfer-storage facility for oil tanker shipments. The hydronic system having heat exchangers placed at shallow depth (for warming) and deeper depth (for cooling) laying on the bottom of the deep-water body (here, coastal waters) where heat is conducted between the ambient water body and the fluid in the heat exchangers, according to at least one embodiment described herein. The diagram showing a hydronic system having incoming and returning fluid regulators.

FIG. 4B shows one example of a double hull tank 408 storing heavy and extra-heavy crude oil or heavy fuel oil, reconstructed so hydronic fluid is circulated between the tank walls.

FIG. 5 is a block diagram showing placement of a hydronic system to cool crude oil stored in tanks (to reduce fugitive emissions of methane and VOCs) on a land site where crude oil is extracted by wells operating on oil fields, according to at least one embodiment described herein (see EXAMPLE 1).

FIG. 6 shows a position of the system of FIG. 5 relative to existing crude oil production infrastructure (separator), according to at least one embodiment described herein (see EXAMPLE 1).

FIG. 7 is a block diagram showing placement of a hydronic system to warm gathering pipelines (to inhibit the formation of hydrates inside the gathering pipelines) at onshore wells extracting raw natural gas, according to at least one embodiment described herein (see EXAMPLE 2).

FIG. 8 shows a position of the system of FIG. 7 relative to existing natural gas production infrastructure (gas production unit), according to at least one embodiment described herein (see EXAMPLE 2).

FIG. 9 is a block diagram showing placement of a hydronic system to warm gathering pipelines carrying heavy crude oil (to inhibit the forming of a wax coating inside the pipelines) on the field site where crude oil is extracted by wells operating on land, according to at least one embodiment described herein (see EXAMPLE 3).

FIG. 10 shows an application of the systems, devices and methods described herein to marine transfer-storage facilities where oil tankers offload crude oil of various API gravities to land-based storage tanks. Here, the system is shown where marine vessels could be carrying crude oil produced at either onshore oil wells or offshore oil wells (see EXAMPLE 4).

FIG. 11 is a block diagram showing placement of a hydronic system to warm gathering pipelines carrying raw natural gas (to inhibit condensate formation) at a natural gas production facility in a geographic region where cold winter weather increases the risk of gathering pipeline blockage by liquid condensate slugs according to at least one embodiment described herein (see EXAMPLE 5).

FIG. 12 shows a position of the system of FIG. 11 relative to existing natural gas infrastructure (gas production unit), according to at least one embodiment described herein (see EXAMPLE 5).

FIG. 13 shows a block diagram showing placement of a hydronic system at a natural gas production facility to cool the lease condensate stored in tanks (to reduce fugitive emissions and also to prevent explosion and fire), according to at least one embodiment described herein (see EXAMPLE 5).

FIG. 14 is a block diagram showing placement of a hydronic system at a crude oil production site where cold winter weather increases the risk of pipeline blockage by ice for pipelines carrying produced water to storage on site, according to at least one embodiment described herein (see EXAMPLE 6).

FIG. 15 is a block diagram showing placement of a hydronic system at a natural gas production site where cold winter weather increases the risk of pipeline blockage by ice for pipelines carrying produced water to storage on site, according to at least one embodiment described herein (see EXAMPLE 6).

FIG. 16 a block diagram showing placement of a hydronic system to cool pipelines carrying volatile distillates from a refinery to storage in a tank farm (to reduce a risk of explosion and fire), according to at least one embodiment described herein (see EXAMPLE 7).

FIG. 17 a block diagram showing placement of a hydronic system to cool pipelines carrying volatile petrochemicals from a chemical plant to storage in a tank farm (to reduce a risk of explosion and fire), according to at least one embodiment described herein (see EXAMPLE 7).

FIG. 18 is a graph showing temperature dependence of benzene vapor pressure (as described in EXAMPLE 1).

FIG. 19 is a graph showing a methane hydrate pressure sensitive phase diagram (as described in EXAMPLE 2).

FIG. 20 is a graph showing dependence of wax precipitation on temperature and pressure (as described in EXAMPLE 3).

FIG. 21 is a graph showing temperature dependence of the viscosity of crude oils with a range of API gravities (as described in EXAMPLE 4).

FIG. 22 is a graph showing typical phase envelope for three stages of natural gas (as described in EXAMPLE 5).

FIG. 23 is a graph showing phase envelope for water with temperature and pressure (as described in EXAMPLE 6).

FIG. 24 is a graph showing flammable mixture as a function of temperature (as described in EXAMPLE 7).

FIG. 25 is a graph showing API gravity versus specific gravity.

Further aspects and features of the example embodiments described herein will appear from the following description taken together with the accompanying drawings.

### DESCRIPTION OF EXAMPLE EMBODIMENTS

Various apparatuses, methods and compositions are described below to provide an example of at least one embodiment of the claimed subject matter. No embodiment described below limits any claimed subject matter and any claimed subject matter may cover apparatuses and methods that differ from those described below. The claimed subject matter are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed subject matter. Any subject matter that is disclosed in an apparatus, method or composition described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially,” “about” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive-or. That is, “X and/or Y” is intended to mean X, Y or X and Y, for example. As a further example, “X, Y, and/or Z” is intended to mean X or Y or Z or any combination thereof. Also, the expression of A, B and C means various combinations including A; B; C; A and B; A and C; B and C; or A, B and C.

The following description is not intended to limit or define any claimed or as yet unclaimed subject matter. Subject matter that may be claimed may reside in any combination or sub-combination of the elements or process steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

Recently, there has been a growing interest in developing new systems, devices and methods of controlling a temperature of a fluid in a storage facility using hybrid natural infrastructure.

The infrastructure of the systems, devices and methods described herein is a form of hybrid natural infrastructure. Natural infrastructure is the atmosphere, land, freshwater bodies, coastal seas and open oceans that provide ecosystem services for human health and wellbeing. Hybrid natural infrastructure is the combination of human-built infrastructure with natural infrastructure. Examples of hybrid natural infrastructure include but are not limited to a reservoir with hydropower dam, solar power facility, wind power facility, and tidal power facility.

The cooling capability of rivers, reservoirs, lakes and coastal seas (known as deep water cooling) can mitigate the effect of extreme seasonal temperature for a myriad of commercial operations. Engineering that takes advantage of cold seawater to replace conventional air conditioning systems (i.e., Seawater Air Conditioning or SWAC) in human-occupied buildings is now used in many coastal cities.

Hydronic systems can warm as well as cool. Radiant heating is a category of Heating, Ventilation, and Air Conditioning (HVAC) technology that warms an indoor environment by convection and radiation. Radiant heating uses a source of moderate temperature and a relatively large surface to warm an indoor space.

These systems have not been applied to the temperature control of oil and gas industry facilities near a deep-water body. The systems, devices and methods described herein include a hydronic system to enhance the climate resilience of oil and gas industry operations. The systems, devices and methods described herein can both warm and cool existing oil and gas industry infrastructure.

For example, tanks storing conventional crude oil can be cooled by the systems, devices and methods described herein to reduce fugitive emissions of methane (a greenhouse gas) and volatile organic carbons (air pollutants). Not all associated natural gas (mostly methane and heavier alkanes) is released when the pressure drops at the crude oil well head. Some gas remains in the extracted crude oil which acts as a solvent. The petroleum industry is committed to reducing fugitive emissions. In the petrochemical industry, cooling a storage tank holding flammable volatile products could reduce vapors, making storage tank operations safer from explosion and fire.

The warming capability of the systems, devices and methods described herein can prevent damage to oil and gas facilities during extreme cold weather events. Low temperatures can freeze excess moisture in pipework. Ice may form and block pipes and valves. Water freezing and expanding can damage piping, causing leaks. The formation of hydrates blocking raw (untreated) natural gas piping can occur even above freezing temperatures. Pipelines and valves can be warmed by the hydronic systems described herein, inhibiting the formation of liquid condensate slugs in the raw (untreated) natural gas piping. A liquid condensate plug in a gas pipeline is an explosion hazard.

The systems, devices and methods described herein can also be referred to as a clean technology that enhances the climate resilience of oil and gas industry operations. The systems, devices and methods described herein may be used as an “add-on” to existing infrastructure in upstream, midstream and downstream industry operations. Furthermore, the systems, devices and methods described herein may be considered to be low-carbon in that, in at least one embodiment, the systems, devices and methods described herein may not require energy input, other than the electricity needed to pump freshwater through the hydronic system, to either warm or cool existing industry infrastructure.

### Applications

The systems, devices and methods described herein may be applied to several existing systems within oil and gas industry infrastructure.

For example, in at least one embodiment, the systems, devices and methods described herein may, by cooling, reduce fugitive emissions of methane and VOCs from light crude oil and medium crude oil produced by onshore and offshore oil wells and stored in land-based tanks.

For example, in at least one embodiment, the systems, devices and methods described herein may, by warming, inhibit the formation of hydrate plugs inside gathering pipelines at onshore wells producing raw natural gas.

For example, in at least one embodiment, the systems, devices and methods described herein may, by warming, inhibit the forming of a wax coating inside gathering pipelines carrying heavy crude oil produced by onshore oil wells.

For example, in at least one embodiment, the systems, devices and methods described herein may, by warming, maintain or reduce the viscosity of heavy and extra-heavy crude oil pumped through pipelines.

For example, in at least one embodiment, the systems, devices and methods described herein may, by warming, inhibit formation of liquid condensate slugs in gathering pipelines carrying raw natural gas at natural gas production wells on land.

For example, in at least one embodiment, the systems, devices and methods described herein may, by warming, inhibit formation of water ice in pipelines and valves carrying raw natural gas or carrying industry facility produced water to tank storage.

For example, in at least one embodiment, the systems, devices and methods described herein may, by cooling, alter the flammability mixture of vapors and air in petroleum distillate storage tanks and in petrochemical storage tanks, reducing the risk of explosion and fire.

For example, in at least one embodiment, the systems, devices and methods described herein may provide a supplemental water supply for firefighting with foam at petroleum distillate storage tank farms and at petrochemical storage tank farms.

At least some of these applications and the problems with current solutions are described in greater detail below.

In at least one embodiment, the systems, devices and methods described herein may address at least three technical problems in the oil and gas industry: (1) fugitive emissions control in the production of crude oil; (2) assurance of flow in pipelines transporting crude oil, natural gas and distillate fuels; and (3) explosion risk control and fire prevention in the storage of flammable petroleum and petrochemical products.

The fugitive emission of methane significantly contributes to anthropogenic climate change. The fugitive emission of volatile organic compounds contributes to air pollution which significantly impacts human health. The systems, devices and methods described herein aim to reduce methane emissions and contribute to efforts to slow global warming. The systems, devices and methods described herein may also reduce long term air pollution linked to human cancers.

There are companies in the United States, Canada and Europe that manufacture methane mitigation equipment and/or offer services. However, these are only infrastructure maintenance efforts to detect and stop methane gas leaks through seals and valves in pipelines.

Within the past decade the environmental issue of anthropogenic climate change has many countries in the world placing new regulations concerning emission of GHGs on industry. Current technology to reduce fugitive emissions of methane and VOCs from crude oil storage tanks is insufficient. A problem on this global scale (i.e., thousands of storage tanks around the world) requires a relatively simple and inexpensive technological solution.

The systems, devices and methods described herein offer a simple operation of cooling the crude oil stored in land-based tanks that may exponentially reduce fugitive emissions, and can be scaled up to any number of storage tanks at a tank farm.

The systems, devices and methods described herein may also offer assurance of flow in pipelines transporting crude oil. natural gas and distillate fuels.

Maintaining fluid flow though pipelines is a continual challenge that petroleum engineers face. Hydrates (also called methane clathrates) commonly form during natural gas production operations when water is condensed in the presence of methane under pressure. Once formed, ice-like hydrates can block pipelines (especially at pipe elbows) and oil-gas-water separation equipment. By warming, the systems, devices and methods described herein may inhibit the formation of hydrate plugs inside gathering pipelines carrying raw (untreated) natural gas, assuring continual flow through the lines.

Viscosity and wax content are properties of crude oil important to its flow through pipelines. Heavy crude oil contains dissolved paraffin waxes that can precipitate under cold ambient environmental conditions. The precipitate can form a wax coating on the inside walls of pipelines. A buildup of wax coating can restrict flow through the pipeline, affecting crude oil production operations. By warming, the systems, devices and methods described herein may inhibit the forming of a wax coating inside a pipeline carrying heavy crude oil. The result is maintenance of flow of the heavy crude through pipelines.

Oil viscosity is the measure of the oil's resistance to flow. The viscosity of crude in pipelines depends on the oil's temperature and hydrocarbon composition. When crude is pumped through a pipeline, a pressure difference between the two ends of the pipeline is needed to sustain the flow. The needed pump pressure is proportional to the oil's viscosity. The systems, devices and methods described herein may be used to warm heavy and extra-heavy crude oil, maintaining the viscosity and flow through existing industry pipelines during cold weather conditions. If not warmed, cold air temperatures would increase the viscosity and the force of pumping would need to be increased.

Heavier alkanes within raw natural gas extracted from gas wells will condense to a liquid state if the temperature and pressure of the gas is dropped to atmospheric conditions. The condensed hydrocarbons can form liquid slugs that can affect pumping operations. The condensate is flammable and explosive. Pipeline crews working in areas where volatile condensate has escaped a leaking pipeline can become asphyxiated. The systems, devices and methods described herein may, by warming, inhibit the formation of liquid condensate slugs inside a pipeline carrying raw (untreated) natural gas.

Extreme cold weather can result in freezing of water inside a pipeline carrying natural gas or carrying produced water from oil-gas-water separator equipment. There is then a risk of flow line blockage. The systems, devices and methods described herein offer may, by warming, maintain pipeline operations during cold weather events.

Explosion hazards exist at downstream petroleum processing facilities worldwide. Catastrophic fires at oil refineries and petrochemical plants have occurred in the past and are still occurring. These accidental fires are costly to the industry and subject local communities to smoke and toxic gases. The systems, devices and methods described herein offer a simple operation of cooling volatile hydrocarbons stored in land-based tanks. Further, the systems, devices and methods described may reduce the risk of explosion and fires at storage tanks near oil refineries and petrochemical plants. The systems, devices and methods described herein may add to firefighting capabilities at refinery distillate storage tank farms and at petrochemical storage tank farms, and/or may also be used to supplement the local water supply for making firefighting foam.

In the systems, devices and methods described herein, to achieve reduced fugitive emissions, the crude oil transfers its heat to the cooling freshwater hydronic system, as oil has a lower heat capacity than water. As noted above, the systems, devices and methods described herein can warm as well as cool crude oil, to maintain the viscosity of the crude oil. The transfer of heat from the warming freshwater in the systems, devices and methods described herein to raw (i.e., untreated) natural gas in production well gathering pipelines inhibits the formation of ice-like hydrates and the formation of liquid condensate slugs in the industry pipelines.

The transfer of heat from the warming freshwater in the systems, devices and methods described herein to the heavy crude oil in an industry pipeline would reduce the viscosity of the oil and would also inhibit the forming of a wax coating inside the pipeline. Viscosity and wax content are properties of crude oil important to its flow through pipelines. The warming ability of the systems, devices and methods described herein is a low-carbon alternative to the “heat tracing” currently used by industry to inhibit the formation of ice in pipeline elbows and dead legs. Heat tracing uses fossil fuel burning to create the heat applied to pipes, tanks, and pump equipment to inhibit ice from blocking flow.

In at least one embodiment, the operation of the systems, devices and methods described herein may have a negligible environmental impact.

During operations, water is not removed from any natural deep-water body, as in SWAC operations using coastal seawater. In the systems, devices and methods described herein, the heat added or removed from the deep-water body (reservoir, lake, river or coastal sea) would be insignificant in comparison to the heat capacity of the large water volume in which the underwater system heat exchangers are immersed. Natural winds and current mixing would dissipate any temperature gradients created by the heat exchangers laying on the bottom of the reservoir, lake, river or coastal sea.

With freshwater as the pumped fluid in the systems, devices and methods described herein, there would be negligible environmental impact if the steel piping of the hydronic system was ruptured by accident, wind storm or storm-driven waves. There would be negligible environmental impact if the installed system was ruptured, spilling simply freshwater at the industry site.

Further, there is no intake of water from the utilized deep-water body into the pipes of the systems, devices and methods described herein. Therefore, no intake of small life stages of aquatic species, e.g., fish and shellfish living in the deep-water body utilized by the warming/cooling hydronic systems described herein. The underwater heat exchangers of the closed-loop hydronic system would rarely require biofouling maintenance.

In addition to the above, the systems, devices and methods described herein reduce fugitive methane emissions to the atmosphere. Methane is a greenhouse gas contributing significantly to anthropogenic global warming.

Further still, in at least one embodiment, the systems, devices and methods described herein may utilize “renewable energy.” Renewable energy refers to energy derived from natural sources that are replenished at a higher rate than they are consumed. The warming/cooling hydronic systems, devices and methods described herein do not deplete the seasonally-renewable, vertical thermal-structure of the utilized deep-water body. Electrical energy (possibly generated on site by solar power or wind turbine power) is used to pump freshwater through the hydronic system.

In at least one embodiment, the dual warming/cooling capability of the systems, devices and methods described herein may be installed “upstream,” meaning, for example, at pipelines and storage tank facilities near oil production wells and natural gas production wells on land. The systems, devices and methods described herein can be installed “midstream,” meaning, for example, at pipelines of land distribution terminals and pipelines of marine transfer-storage facilities. The systems, devices and methods described herein can be installed “downstream,” meaning, for example, at pipelines of petroleum distillate storage tank farms near oil refineries and at pipelines of petrochemical storage tank farms near chemical plants.

The systems, devices and methods described herein use deep water for cooling and shallow water for warming. Accordingly, the systems, devices and methods described herein may be used at petroleum storage tank farms and petrochemical storage tank farms located along the shorelines of major lakes, rivers and coastal waters where the deep-water body has the required vertical thermal-structure. The thermal-structure of the nearshore waters has cold water available for the heat exchanger system at deeper depths. Surface waters are warmed by the sun, and available for the heat exchanger system at shallow depths.

The cooling capability of the systems, devices and methods described herein would also be useful at petroleum storage tank farms in geographic regions where hot weather increases the fugitive emission of methane and VOCs from stored conventional crude oil. Similarly, the cooling capability of the systems, devices and methods described herein would be useful at petrochemical storage tank farms in geographic regions where hot weather increases the vapors of stored petrochemicals and increases the risk of explosion and fire. The degree of flammability depends upon the volatility of the stored petrochemical. Volatility is related to its vapor pressure, which is temperature dependent. Cooling the stored petrochemical decreases the risk of explosion and fire. The cooling capability of the systems described herein would therefore be particularly useful at petroleum storage facilities near oil refineries and at petrochemical storage facilities near petrochemical plants along the U.S. Gulf of Mexico coast, where hot ambient air temperature occurs during the spring, summer and fall months.

The warming capability of the systems, devices and methods described herein would be useful at natural gas production facilities in geographic regions where cold winter weather increases the risk of gathering pipeline blockage by hydrate plugs, liquid condensate slugs and water ice. Perhaps surprisingly, the warming capability of the systems, devices and methods described herein would be useful at natural gas facilities along the U.S. Gulf coast oil where unusual severe cold weather events are becoming more common with the changing climate. In February of 2021, the U.S. Gulf coast experienced a severe snow and ice storm. The storm was among the worst natural disasters in the history of Texas.

The warming capability of the systems, devices and methods described herein would be useful at marine ship refueling facilities located in high latitude geographic regions (e.g., Arctic and Subarctic regions) where cold weather affects the flow characteristics of marine ship fuels. The pour point is the temperature below which an oil (e.g., diesel) loses its flow characteristics. The gel point is the temperature at which an oil cannot flow by gravity or be pumped though a pipeline. The systems, devices and methods described herein can warm marine fuel oil, maintaining its flow through existing ship refueling pipelines. If the pipelines of a marine ship refueling facility are not warmed, extreme cold weather temperatures could cause the fuel to gel and thereby limit ship refueling operations. Glycol could be added to the freshwater in the hydronic systems, devices and methods described herein as an antifreeze agent. The warming capability of the systems, devices and methods described herein would be useful at marine refueling stations, for example in northern geographic locations such as Alaska and the Canadian northern archipelago. A refueling station not equipped to warm its fuel tanks would be limited in its seasonal period of operation. There is no burning of fossil fuel on site in creating the warming ability of the hydronic systems described herein.

A hydronic system according to at least one embodiment described herein may be useful in several ways relative to existing oil industry infrastructure. Again, the hydronic system could be configured and operated for cooling for one purpose or for warming for another purpose. The dual warming/cooling capability of the hydronic system can also be installed upstream, midstream, and downstream at existing industry storage tank facilities on land.

The hydronic systems described herein can reduce the escape to the atmosphere of commercially valuable light hydrocarbons (natural gas dissolved in the crude oil) from the stored crude oil. Escaping light hydrocarbons include methane, which is a potent GHG, and benzene, which is a carcinogenic and neurotoxic volatile organic compound (VOC). Fugitive emissions from petroleum storage tanks are a source of air pollution linked to human cancers.

Fugitive emissions fall under government regulations regarding air quality in many developed countries of the world. The global petroleum industry has been attempting to reduce fugitive emissions to reduce air pollution. During the 1960s the industry developed crude oil storage tanks with a floating-roof to reduce fugitive emissions. The vertically moving roof floats on the surface of the stored crude oil, minimizing the vapor space at the top of the storage tank.

However, there is always evaporation through the floating-roof seals, and “flashing losses” remain. In the 1990s industry developed vapor recovery units (VRUs) to trap fugitive emissions from crude oil storage tanks without a floating-roof. The VRU condenses the fugitive emissions and pumps the condensed vapor into a gas pipeline. A sales natural gas pipeline must be present on site to remove the compressed gas. The requirement for a sales natural gas pipeline limits the use of VRU technology at many oil storage tank sites.

For example, a hydronic system according to at least one embodiment described herein may be positioned between the crude oil as it is pumped out of ground under pressure and storage tanks.

By cooling, the hydronic system could reduce the escape to the atmosphere of commercially valuable methane and air-polluting VOCs from the stored crude oil. The system can cool the oil pumped into the tank, reducing the vapor pressure in the top of the storage tank.

The hydronic system may cool conventional light crude oil and medium crude oil in existing industry pipeline infrastructure as the crude oil is pumped into land-based storage tanks. Loading and unloading crude oil tank operations take place at upstream oil well field sites, midstream distribution terminals, marine transfer-storage facilities and downstream refineries, for example.

If stored at a cooler temperature, light crude oil and medium crude oil will emit less methane and less VOCs. The fundamental chemistry here is that emission of light hydrocarbons from crude oil decreases exponentially with linearly decreasing temperature. Fugitive emissions from the stored crude would be significantly reduced if the crude is stored at a cooler than ambient temperature.

Because oil has a lower heat capacity than water, the temperature of stored oil can be changed efficiently by the hydronic cooling system according to at least one embodiment described herein. The systems, devices and methods described herein may also mitigate the increase in temperature of the oil in the tank due to daily solar heating of the tank exterior, reducing “tank standing, tank breathing losses.” There is also a lower vapor pressure during filling and emptying the tank, reducing “tank working losses.”

Fundamental physical properties of petroleum and water make the systems, devices and methods described herein an efficient cooling hydronic system. The specific heat capacity of freshwater (by volume) is about twice that of crude oil (by volume). Heat is transferred from the crude oil in the industry pipeline to the water in the hydronic system by convection and radiation, or by conduction.

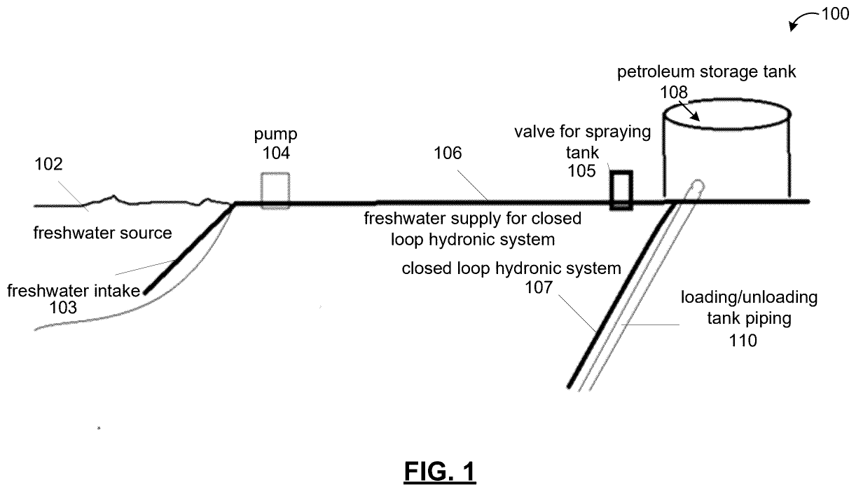

Reference is now made to FIG. 1, which illustrates a hydronics system 100 for controlling a temperature of a petroleum storage tank. Here, system 100 uses water from a freshwater source 102 to fill the hydronic piping.

The hydronic systems, devices and methods described herein typically circulate water through steel pipes. The freshwater that initially fills the hydronic system 100 is supplied by a local freshwater source 102, e.g. a reservoir, river, lake or pond. The freshwater source 102 may or may not be the deep-water body used by the hydronic system 100 for warming/cooling industry pipelines and storage tanks on the industrial site as previously described.

In at least one embodiment, the hydronic systems for controlling temperature as described herein do not require energy input other than electricity needed to pump the fluid (e.g. freshwater) through pipes of the hydronic system. For example, there may be no combustion of fossil fuels to generate energy for warming or cooling the industry pipelines and storage tanks on the industrial site.

In the embodiment of system 100 shown in FIG. 1, pipeline 106 from the freshwater intake 103 to the closed loop hydronic pipeline 107 may be covered by solar panels. Adding local solar power or wind turbine power to the industry site enables pump 104 to supply the hydronic fluid if there is a power failure at the industrial site or marine refueling station.

The solar panels may be laid over the piping 106 supplying the freshwater for the hydronic system. This minimizes the industrial site land needed for the system at the industrial site.

For example, solar power or wind turbine power with battery storage could supply electricity for pumping the water throughout the hydronic systems described herein during local power blackouts.

In the embodiment of system 100 shown in FIG. 1, a water tower could also supply pressure to the hydronic system during electrical power blackouts, according to at least one embodiment described here.

System 100 includes a pump 104 for pumping water via freshwater intake 103 from freshwater source 102 through pipelines 106 for controlling a temperature of the petroleum inside a petroleum storage tank 108. Valve 105 can control flow of the water from freshwater source 102. Valve 105 may provide freshwater for making foam for firefighting at the industrial site or marine refueling station. System 100 may also include water from freshwater source 102 being pumped through the closed-loop hydronic pipeline 107 adjacent to, around or surrounding, loading/unloading tank piping 110 to control the temperature of petroleum therein.

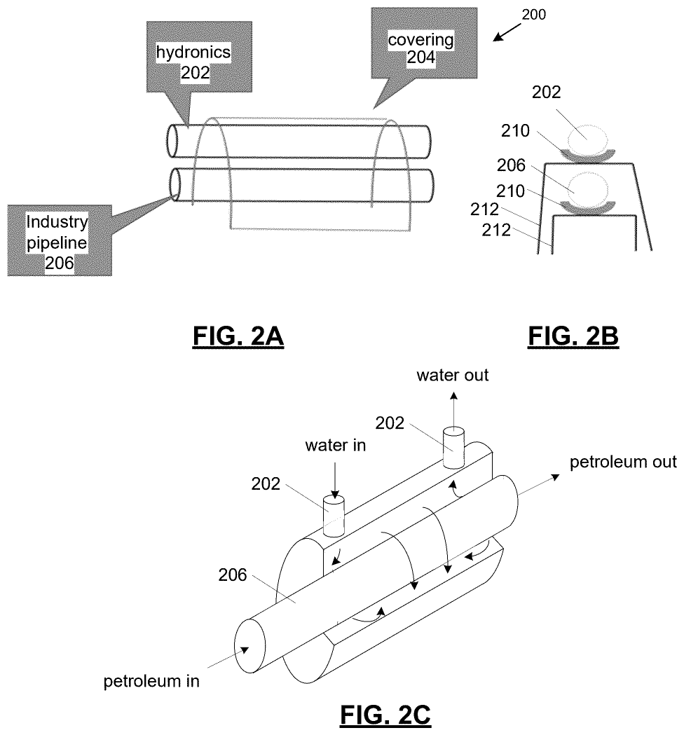

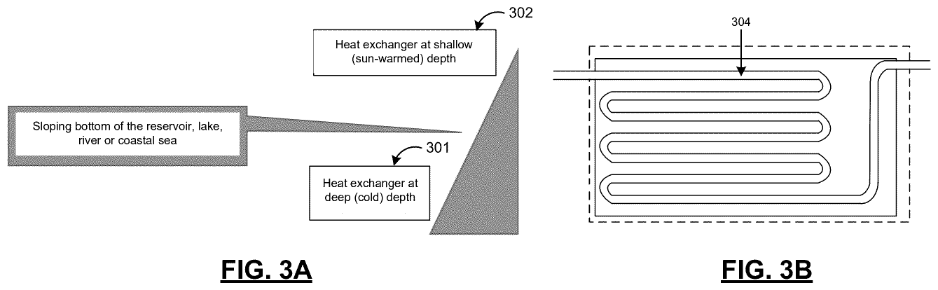

FIG. 2A and FIG. 2B show a perspective view and an end view, respectively, of one example of a portion of a hydronics system 200 according to at least one embodiment described herein. Hydronic system 200, as well as other embodiments described herein, may be referred to as an “add-on” to existing industrial infrastructure that does not require alteration of existing operations or existing storage tank structure. Only minor modifications (e.g., adding parallel warming/cooling piping and wrapping material) to existing industry infrastructure piping may be required.

In system 200, hydronic pipelines 202 are shown as part of a covering 204 placed around an existing industry pipeline 206. Covering 204 may, optionally, include a outer cover that surrounds the hydronics pipeline(s) 202 and the existing industry pipeline 206. Covering 204 may also optionally include insulation positioned between the cover and the pipelines 202, 206. Cooling or warming by the hydronic systems described herein may be by radiative and convective heat transfer. Cooling or warming by the hydronic systems described herein may not be by conductive heat transfer. As shown therein, hydronic pipeline 202 may be positioned directly above, along (i.e., having a similar length to) and adjacent (i.e., close to, near or touching) to the existing industry pipeline 202. In another embodiment, hydronic pipelines 202 may include more than one pipe that, collectively, is arranged to partially or completely surround the existing industry pipeline.

FIG. 2B shows one example of how existing industry pipelines 206 may be supported, such as by one or more carriages 210 and/or support members 212. FIG. 2C shows a perspective view of one example of a portion of a hydronics system 200 according where industry pipeline 206 is the inner tube of a concentric tube arrangement, the hydronic pipeline 202 being the outer tube. Here, major modifications (e.g., building the concentric tube arrangement) may be required at the industry site.

In at least one embodiment, the closed-loop hydronic systems described herein may include piping placed over and parallel to the existing industry pipelines, but not touching so as to avoid abrasion of the existing pipelines.

In at least one embodiment, the systems, devices and methods described herein may include a hydronic piping configuration in relation to the existing tank transfer piping that uses a concentric tube arrangement (i.e., the hydronic piping surrounding the inner existing tank transfer piping) to maximize the heat transfer by conduction. This concentric tube counter-flow or parallel-flow arrangement (see FIG. 2C) would be used where radiative and convective heat transfer would not be practical or effective. Heat exchange effectiveness is important for the overall thermal efficiency of the systems, devices and methods.

In the application where the hydronic system is for cooling an industry pipeline with crude oil (e.g., to reduce fugitive emissions of methane and VOCs), the parallel industry pipeline and the closed-loop hydronic system piping may be wrapped together with material to enhance heat transfer from the warmer petroleum in the industry pipeline to the cooler freshwater in the closed-loop hydronic system.

In applications where the hydronic system is for warming an industry pipeline with raw natural gas (e.g., to inhibit the formation of hydrate plugs or liquid condensate slugs), the combined hydronic and industry gas pipeline may be covered by material to enhance heat transfer from the warmer freshwater in the hydronic system to the cooler raw natural gas.

Although the hydronics shown in FIGS. 2A-2C are shown by way of hydronics pipeline(s) 202 relative to industry pipeline 206, it should be understood that similar arrangements could be implements with other infrastructure, including but not limited to hydronic(s) pipelines 202 and other existing industry vessels, such as but not limited to pipelines, storage tanks, well heads or the like.

FIG. 3A shows a diagram of placement of two heat exchangers 301, 302 of a hydronic system according to at least one embodiment described herein. In FIG. 3A, a first heat exchanger 301 is positioned at a deep (e.g., cold) depth (e.g., greater than about 10 feet) and a second heat exchanger 302 is positioned at a shallow (e.g., sun-warmed) depth (e.g., about 10 feet or less) in a deep-water body (reservoir, lake, river or coastal sea, or the like, near the industrial site.

The systems, devices and methods described herein utilize a readily available, reliable and renewable heat source/sink, i.e., the vertical thermal-structure of a reservoir, lake, river or coastal sea for warming and cooling. Heat exchangers with the closed-loop piping of the hydronic systems described herein are placed at both a deep (cold) depth and a shallow (sun-warmed) depth in any deep-water body near the industrial site.

FIG. 3B shows one example of a heat exchanger for use with the systems described herein. For temperature control of industry infrastructure (e.g., pipelines and storage tanks existing at the industrial site), the freshwater pumped through the hydronic steel pipes 304 submerged in the nearby water body equilibrates with the temperature of the water body at the operating depth (shallow depth for warming or deep depth for cooling).

Generally, there is no intake of water from this utilized water body into the pipes of the closed-loop, warming/cooling hydronic system.

The closed-loop hydronic systems described herein use deep water for cooling and shallow water for warming. Good results may occur at petroleum storage tank farms and petrochemical storage tank farms located along shorelines where the utilized water body has the required vertical thermal-structure. The thermal-structure of the nearshore waters has cold water available for the cooling system at depth. Surface waters are warmed by the sun, and available for the warming system.

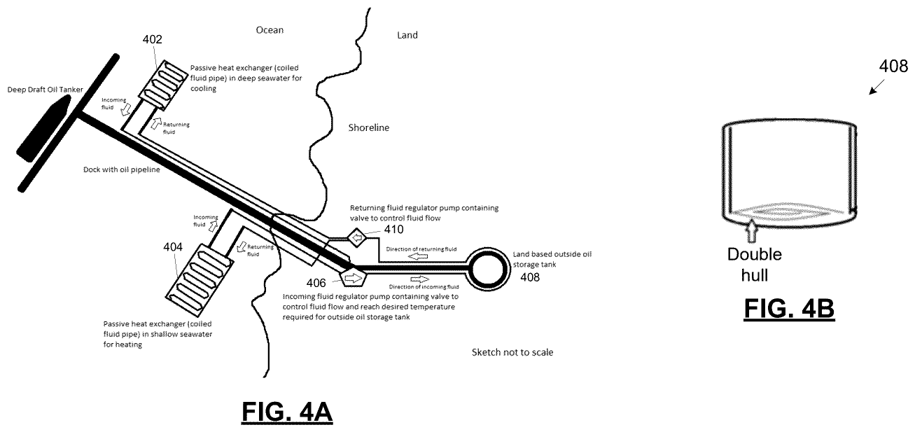

FIG. 4 shows an example of a hydronic system 400 applied at a marine transfer-storage facility with docked oil tanker for controlling the temperature of land-based outdoor oil storage tanks and/or oil pipelines leading thereto. The marine transfer-storage facility may be in any deep-water environment. Several oil tanker shipment transfer-storage facilities are located along Great Lakes shorelines in the U.S. and Canada. The application here would be analogous for a deep-water Great Lakes shoreline. In at least one embodiment described herein, the systems, devices and methods circulate freshwater through steel pipes. The freshwater that initially fills the hydronic system is supplied by a local source, e.g., reservoir, river, lake or pond. This local source of freshwater may or may not be the deep-water body in which the passive heat exchanges are submerged. In at least one embodiment described herein, the systems, devices and methods circulate fresh water through steel pipes.

System 400 includes a first passive heat exchanger 402 positioned in deep water for cooling. System 400 also includes a second passive heat exchanger 404 positioned in shallow water for warming. In at least one embodiment, the first passive heat exchanger 402 and the second passive heat exchanger 404 include steel pipes lying directly on a bottom of the deep-water body (i.e., local reservoir, river, lake or coastal sea).

Incoming fluid from the first passive heat exchanger 402 and incoming fluid from the second passive heat exchanger 404 meet at an incoming fluid regulator 406. Incoming fluid regulator 406 includes temperature sensing means as well as a valve. Upon determining a temperature of the incoming fluid, a processor for the regulator pump 406 is configured to control the valve to control hydronic fluid (e.g., freshwater) flow from each of the first passive heat exchanger 402 and second passive heat exchanger 404 to provide for the fluid exiting the fluid regulator pump to be at a desired temperature for cooling or warming the oil storage tanks 408.

After circulating around the industrial infrastructure, the hydronic fluid (freshwater) is then pumped back into the steel piping heat exchanger laying on the bottom of the deep body of water. The freshwater in the hydronic system's heat exchanger is again warmed or cooled (depending on the depth of the heat exchanger laying on the bottom), equilibrating with the ambient water temperature. The pumping cycle of the hydronic system is repeated and the industry infrastructure eventually reaches the temperature selected by the human operator for that particular application of the hydronic system.

To return the hydronic fluid (freshwater) to the heat exchangers, system 400 also includes a returning fluid regulator pump 410 containing a valve for controlling fluid flow therethrough. Returning fluid regulator pump 410 receives fluid from cooling or warming the storage tanks 408 and returns the fluid to the first passive heat exchanger 402 or to the second passive heat exchanger 404. Returning fluid regulator pump 410 may include temperature sensing devices to determine a temperature of the incoming fluid. The valve of returning fluid regulator pump 410 may be communicatively coupled to a controller (e.g., a processor) thereof that is configured to, upon receiving temperature information for the sensing devices, control the valve to direct fluid to the first passive heat exchanger 402 or to the second passive heat exchanger 404 in a manner that optimizes the temperature regulation of the fluid.

In at least one embodiment, the controller determines the hydronic fluid with the required temperature sent to a specific infrastructure at the industrial site. For example, to cool crude oil in a storage tank to reduce its fugitive emissions of methane and VOCs, the controller sends the hydronic fluid that was cooled through the heat exchanger 402 at deep depth. Hydronic fluid (freshwater) with the cold temperature is then pumped through hydronic piping placed alongside industry pipelines transferring crude oil to the storage tanks.

The optimal temperature setting in the controller may be selected by a human operator based on the selected application (to warm or cool a specific infrastructure at the industrial site).

For example, to cool crude oil in a storage tank to reduce its fugitive emissions, the hydronic fluid (freshwater) circulated through the heat exchanger 402 at deep depth may be in a range of about 1 degree Celsius (C.) to about 10 degrees C., or of about 1 degree C. to about 5 degrees C.

The heat exchanger 404 at shallow depth may be in water with a temperature range of about 5 degrees C. to about 20 degrees C., or in a range of about 10 degrees C. to about 20 degrees C., or in a range of about 10 degrees C. to about 15 degrees C., or in a range of about 15 degrees C. to about 20 degrees C.

FIG. 4B shows one example of a land-based tank 408 storing heavy crude oil, or marine fuel oil, or diesel fuel. In one example embodiment, tank 408 could be built with double-hulls with the hydronic fluid circulating between the outer tank walls. For example, to warm the heavy crude oil, or marine fuel oil, or diesel fuel to maintain its temperature above the gel point, the controller sends the hydronic fluid through the heat exchanger 404 at shallow depth.

### EXAMPLES

### Example 1—Hydronic System Installed Upstream at Onshore Oil Well Sites Where Light and Medium Crude Oil is Produced

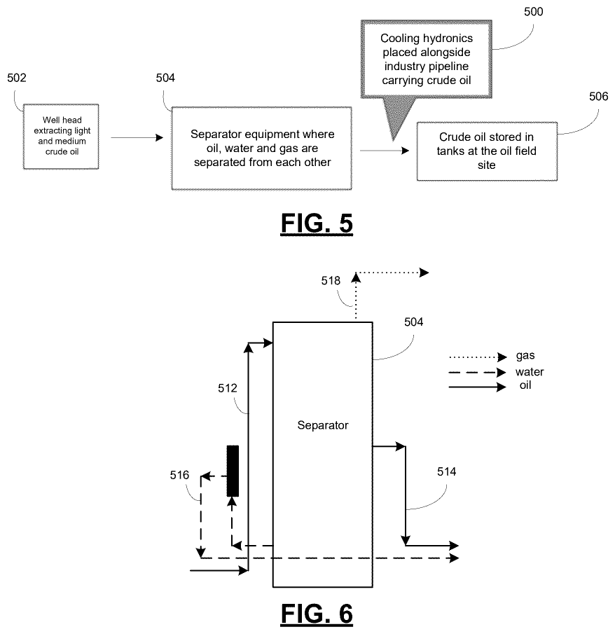

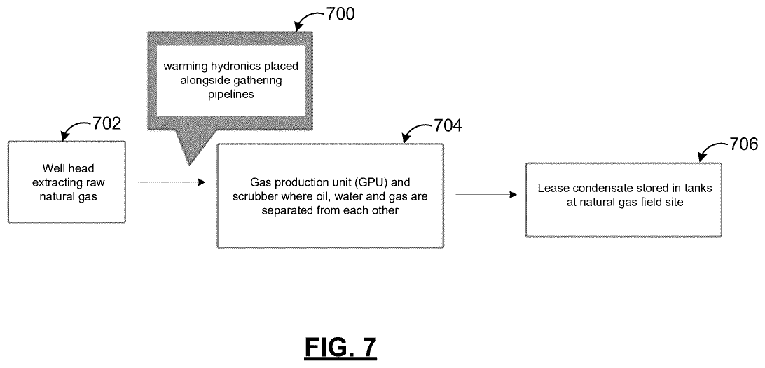

Turning to the drawings, FIG. 5 shows a block diagram of a system for controlling temperatures of oil industry infrastructure, according to at least one embodiment described herein. In this embodiment, the hydronic system 500 to cool crude oil stored in tanks 106 is placed on the land site where light or medium crude oil is extracted by wells operating on oil fields. Extracted oil passes from the well head(s) 502 and subsequently to separator equipment 504. Cooling hydronic system 500 is positioned between the separator equipment 504 and the storage tanks 506.

By cooling, the hydronic system 500 described herein reduces fugitive emissions from light crude oil and medium crude oil produced by onshore oil wells and stored in land-based tanks.

FIG. 6 shows the oil industry separator 504 separates incoming crude oil stream 512 into oil outlet stream 514, water outlet stream 516 and gas outlet stream 518. In some examples, oil outlet stream 514 may proceed to storage and/or a lease automatic custody transfer unit, water outlet stream 516 may proceed to water storage and/or to a water treatment plant and gas outlet stream 518 may proceed to a combustor, a meter run and/or to storage.

In at least one embodiment, to achieve reduced fugitive emissions, the separated crude oil being pumped into storage tanks transfers its heat to the cooling freshwater hydronic system, as oil has a lower heat capacity than water.

The hydronic system of FIG. 5 could reduce the escape to the atmosphere of commercially valuable light hydrocarbons from the stored crude. Escaping light hydrocarbons include methane, which is a potent greenhouse gas (GHG), and benzene, which is a carcinogenic and neurotoxic volatile organic compound (VOC). Fugitive emissions of VOCs from petroleum storage tanks are a source of air pollution linked to human cancers.

Fugitive emissions fall under government regulations in many developed countries of the world. The U.S. Environmental Protection Agency finalized a rule in November 2024 that aims to reduce methane emissions from certain oil and gas facilities. The Methane Emissions Reduction Program of the U.S. Federal Government may reduce emissions of methane and VOCs.

The Canadian Federal Government in December 2023 proposed new regulations respecting reduction in the release of methane and certain VOCs by the upstream oil and gas sector through the introduction of emission standards and work practices at upstream, midstream and transfer facilities.

By cooling, the hydronic system of FIG. 5 could reduce the escape to the atmosphere of commercially valuable methane and air-polluting VOCs from the stored crude. The system can cool the oil pumped into the tank, reducing the vapor pressure in the top of the storage tank.

The hydronic system of FIG. 5 cools conventional light crude oil and medium crude oil in existing industry pipeline infrastructure as the crude is pumped into land-based storage tanks. Loading and unloading tank operations take place at land-based distribution terminals, marine transfer-storage facilities and refineries, for example.

If stored at a cool temperature, light crude oil and medium crude oil will emit less methane and less VOCs. The fundamental chemistry here is that emission of light hydrocarbons from crude oil decreases exponentially with linearly decreasing temperature. Fugitive emissions from the stored crude would be significantly reduced if the crude is stored at a cooler than ambient air temperature.

Because oil has a lower heat capacity than water, the temperature of stored oil can be changed efficiently by the hydronic cooling system according to at least one embodiment described herein. The systems, devices and methods described herein may also mitigate the increase in temperature of the oil in the tank due to daily solar heating of the tank exterior, reducing “tank standing, tank breathing losses.” There is also a lower vapor pressure during filling and emptying the tank, reducing “tank working losses.”

Fundamental physical properties of petroleum and water make the systems, devices and methods described herein an efficient cooling hydronic system. The specific heat capacity of freshwater (by volume) is about twice that of crude oil (by volume). Heat is transferred from the oil in the industry pipeline infrastructure to the fresh water in the hydronic system.

### Example 2—Hydronic System Installed Upstream at Onshore Gas Well Sites Where Raw Natural Gas is Produced

In another embodiment, the warming capability of the systems, devices and methods described herein would be useful at natural gas production sites in geographic regions where cold winter weather increases the risk of gathering pipeline blockage by hydrate plugs.

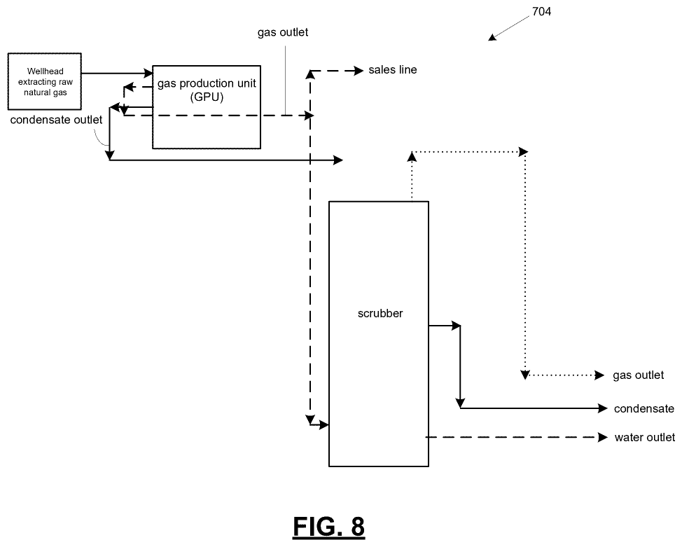

FIG. 7 shows a position of a hydronic system 700 according to at least one embodiment described herein. System 700 is configured to warm gathering pipelines (to inhibit the formation of hydrates inside the gathering pipelines) at onshore wells producing raw natural gas. More specifically, hydronic system 700 may be positioned alongside gathering pipelines between a well head extracting, for example, raw natural gas and the gas production unit (GPU) plus scrubber equipment 704 where oil, water and gas are separated from each other. Downstream from the GPU equipment 704, condensate may be stored in tanks 706 at the natural gas field site.

As shown in FIG. 8, the dual warming/cooling capability of the hydronic system 700 can be installed “upstream,” at natural gas production wells on land. The transfer of heat from the warming freshwater in the hydronic systems described herein to raw (untreated by the GPU and scrubber equipment) natural gas in production well field gathering pipelines inhibits the formation of hydrates in the industry gathering pipelines.

By warming, the systems, devices and methods described herein inhibit the formation of hydrates inside gathering pipelines carrying raw (untreated) natural gas, assuring continual flow through the line.

Hydrates accumulate at restriction in flowlines, chokes, valves, and instrumentation and accumulate into the liquid collection section of vessels.

Hydrates can form during natural gas production operations when water is condensed in the presence of methane at pressure. In raw (untreated) natural gas, liquid water is saturated with methane so that hydrates can form at certain temperatures and pressures. Hydrates can form due to a decrease in temperature with no sudden pressure drop in the pipeline. Hydrates can block gathering pipelines and natural gas processing equipment. Hydrates can accumulate at restrictions in the pipelines (chokes and valves) and accumulate into the liquid collection section of gas processing vessels at the production field site.

Hydrates can form where a sudden expansion of a gas flow line occurs, such as orifices, regulators, chokes. When the pressure of a gas changes, its temperature also changes. In natural gas production, when pressure is reduced across a pipeline control valve, the temperature of the gas is reduced (known as the Joule-Thompson effect).

The most common way the industry will free a pipeline plugged with hydrates is by slow depressurization from both sides of the hydrate plug. However, it takes several days or weeks to dissociate the hydrate plug. Any pressure gradient across the hydrate plug may cause it to move as a speeding projectile along the pipeline, possibly causing pipeline rupture with potential injury to industry workers.

Heating the hydrate plug using a high temperature source (e.g., a blowtorch) is dangerous and not recommended by industry, but sometimes practiced at production field sites. Large, confined pressure increases in the pipeline can rupture the pipe, endangering field workers.

It is better to inhibit hydrates from forming and blocking pipelines. To inhibit hydrate formation, the hydronic systems described here may be used to warm the pipeline carrying the raw natural gas above the hydrate formation temperature of the gas.

### Example 3—Hydronic System Installed Upstream at Onshore Oil Well Sites Where Heavy Crude Oil is Produced

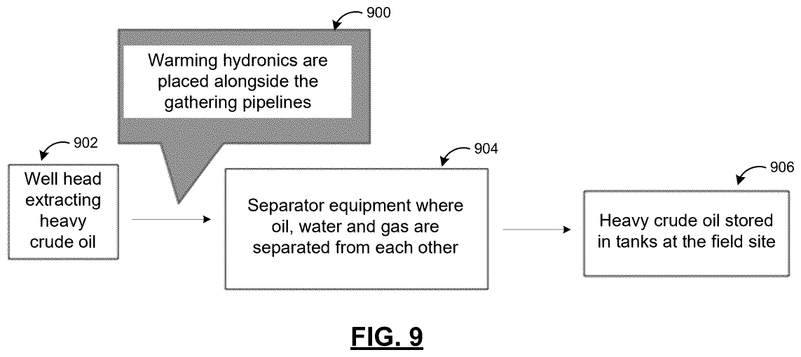

In another embodiment, FIG. 9 shows a hydronic system 900 according to at least one embodiment described herein may be used to warm gathering pipelines carrying heavy crude oil on the site where heavy crude oil is extracted by oil industry infrastructure 902 operating on land oil fields. The gathering pipelines are upstream from separator equipment 904 where oil, water and gas are separated from each other. The hydronic system 900 is configured to inhibit the formation of wax in the crude oil gathering pipelines. The heavy crude oil is stored in tanks 906 at the field site.

Gathering pipelines can carry heavy crude oil long distances between the well head 902 and separation equipment 904. Wax can precipitate in the gathering pipeline as the heavy oil flows and cools due to heat loss to the surrounding environment, By warming, the hydronic systems described herein may inhibit the formation of a wax coating inside gathering pipelines carrying heavy crude oil produced by onshore oil wells. The result may maintain flow of the heavy crude oil through industry pipelines.

Heavy crude oil contains dissolved paraffin waxes and high-molecular-weight asphaltenes that can precipitate and deposit under ambient environmental conditions. Wax deposition in crude oil pipelines during cold weather conditions is a major problem in transporting heavy crude oil. As crude oil is pumped through a pipeline, it flows more quickly near the center of the pipe than near its walls. Wax can form along the inner pipeline walls if the temperature of the crude oil falls below the wax precipitation temperature. The wax accumulating on cold walls of the pipeline thickens the crude oil. To maintain a constant flow rate of crude oil, the pump force must increase. Wax buildup on the inside of the pipeline requires oil pipeline shutdown and expensive maintenance.

Paraffin waxes and asphaltenes that have condensed on pipeline walls can restrict flow, resulting in back pressure. Wax precipitation is strongly dependent on the temperature of the crude oil and weakly dependent on pressure in the pipeline. Wax plugs can be removed by heating the pipeline, pumping hot oil or hot water into the flow line to melt the wax. Industry uses a fossil fuel burning steam plant to produce the hot oil or hot water to be pumped into the flow line.

Chemical dispersants can be added to the produced crude entering the flow line to break up deposited wax. Alternatively, production can be halted so mechanical cutters (called “pigs”) can be sent through the pipeline to scrape away the wax coating from inside the pipeline.

It is better to inhibit wax from precipitating and coating the inside walls of pipelines during cold environmental conditions. To inhibit precipitation, the hydronic systems described herein warm the pipeline carrying the heavy crude oil. By warming the crude oil in the pipeline above the wax precipitation temperature, the heavy crude oil is inhibited from forming a wax coating inside the pipeline wall. The systems, devices and methods described herein may be referred to as “clean-energy” technologies, as there is no burning of fossil fuel (i.e., no combustion heating steam plant) in operating the warming hydronic system.

### Example 4—Hydronic System Installed Midstream Where Heavy or Extra-Heavy Crude Oil is Pumped Through Pipelines to Distribution Terminal Storage Tanks

The systems, devices and methods described herein can warm as well as cool crude oil, for example to maintain or reduce the viscosity of the heavy or extra-heavy crude oil pumped through industry pipelines to midstream tank storage farms.

By warming, the systems, devices and methods described herein can reduce the viscosity of heavy and extra-heavy crude oil pumped through pipelines.

The transfer of heat from the warming freshwater in the hydronic systems described herein to the heavy crude oil in the industry pipeline maintains the viscosity of the oil. Viscosity and wax content are properties of crude oil important to its flow through pipelines.

Further, the systems, devices and methods described herein can be installed “midstream,” at distribution-storage terminals and at marine transfer-storage facilities, where oil tankers offload crude with various API gravities to land-based storage tanks. After storage, the crude is loaded back onto another oil tanker for shipment to market. The systems, devices and methods described herein may warm the heavy and extra-heavy crude oil to maintain its viscosity as it is transferred. To warm the heavy and extra-heavy crude oil, the hydronic systems, devices and methods described herein utilize a heat exchanger placed at shallow depth of the deep-water body (a reservoir, lake, river or coastal sea).

The systems, devices and methods described herein may warm the heavy and extra-heavy crude oil flowing through existing industry pipeline infrastructure. By warming a transfer pipeline, the viscosity of the pumped crude is lowered or remains constant and the pumped flow rate is maintained.

Oil viscosity is the measure of the oil's resistance to flow. It depends primarily on the oil's temperature. At a warmer temperature, heavy and extra-heavy crude oil is more fluid and easier to pump through pipelines during transfer operations.

Current methods for reducing the viscosity of heavy and extra-heavy crude use a combustion steam plant to heat heavy and extra-heavy crude oil in storage tanks. The fossil fuel consumption by the steam plant will be proportional to the heat required to maintain the heavy crude's viscosity. The extent of fossil fuel burning and emission of CO₂ (a greenhouse gas) is dependent on cold weather-related heat loss through the tank walls during the winter.

If not heated, cold weather temperatures would increase the viscosity of the heavy or extra-heavy crude. The force of pumping would need to be increased.

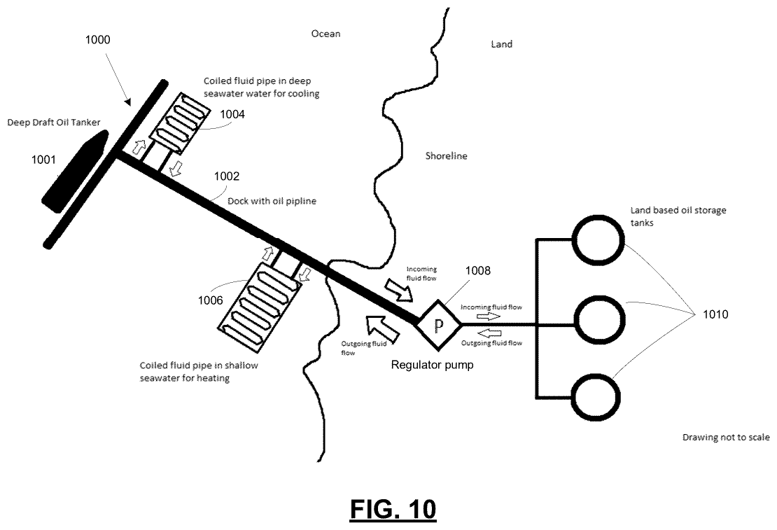

FIG. 10 shows an application of the systems, devices and methods described herein to marine transfer-storage facilities where oil tankers offload crude oil of various API gravities to land-based storage tanks. Here, a system 1000 is shown where marine vessels 1001 could be carrying crude oil produced at either onshore oil wells or offshore oil wells.

Of note, FIG. 10 shows an existing industry crude oil transfer pipe infrastructure 1002 along the landing pier and dock. Hydronic system 1000 includes a first heat exchanger 1004 and a second heat exchanger 1006, each being placed alongside the existing oil transfer pipelines 1002.

The first heat exchanger 1004 for cooling is to reduce fugitive emission of methane and VOCs from the land-based storage tanks 1010 by, for example, lowering the temperature of the crude oil as it is transferred from the marine vessel to the land-based tanks. After storage, the crude oil is loaded back onto another marine vessel for shipment to global markets.

Heat exchanger 1004 is placed at a deep depth (e.g., greater than or about 10 feet). Hydronic fluid (freshwater) circulating within heat exchanger 1004 is pumped from the deep depth upwardly and around the existing industry pipeline infrastructure to cool the crude oil therein. Hydronic fluid can then be recirculated to control the hydronic fluid temperature, for example by a regulator pump 1008.

The heat exchanger 1006 may be used to increase the temperature of heavy crude oil to reduce its viscosity as the crude oil is transferred from the marine vessel to the land-based storage tank(s) 1010. Hydronics system 1000 includes a heat exchanger 1006 positioned at a shallower depth (e.g., between 0 and 10 feet deep) where the water body is sun-warmed. Again, hydronic fluid (freshwater) circulating within the heat exchanger 1006 at shallow depth can be pumped upwardly and around the existing industry pipeline infrastructure to warm the crude oil therein. Hydronic fluid (freshwater) can then be recirculated to control the crude oil temperature, for example by a regulator pump 1008.

Land-based tanks 1008 may store heavy crude oil, extra-heavy crude oil, or marine fuel oil. In one example embodiment, tanks 1010 could be built with double-hulls with the hydronic fluid circulating between the outer tank walls.

The warming capability of the hydronic systems described herein may be useful at marine ship refueling stations in high latitude geographic regions (e.g., Arctic and Subarctic regions) where cold weather affects the flow characteristics of marine fuel oils. The hydronic systems described herein can warm marine fuel oil above its gel point, maintaining its flow through existing ship refueling pipelines. If not heated, extreme cold weather temperatures could limit ship refueling operations. Glycol could be added to the freshwater in the hydronic system described herein as an antifreeze agent in the hydronic fluid.

The warming capability of the hydronic systems described herein could be useful at search and rescue stations and/or ship refueling stations, for example but not limited to in Alaska and the Canadian archipelago. An Arctic station not equipped to warm its diesel fuel tanks and/or marine fuel tanks may not be able to operate year-round. There is no burning of fossil fuel in creating the warming ability of the hydronic systems described herein.

### Example 5—Hydronic System Installed Upstream at Onshore Gas Condensate Well Sites Where Lease Condensate is Produced

The warming capability of the systems, devices and methods described herein would be useful at natural gas production facilities at gas condensate reservoirs in geographic regions where cold winter weather increases the risk of pipeline blockage by liquid condensate slugs.

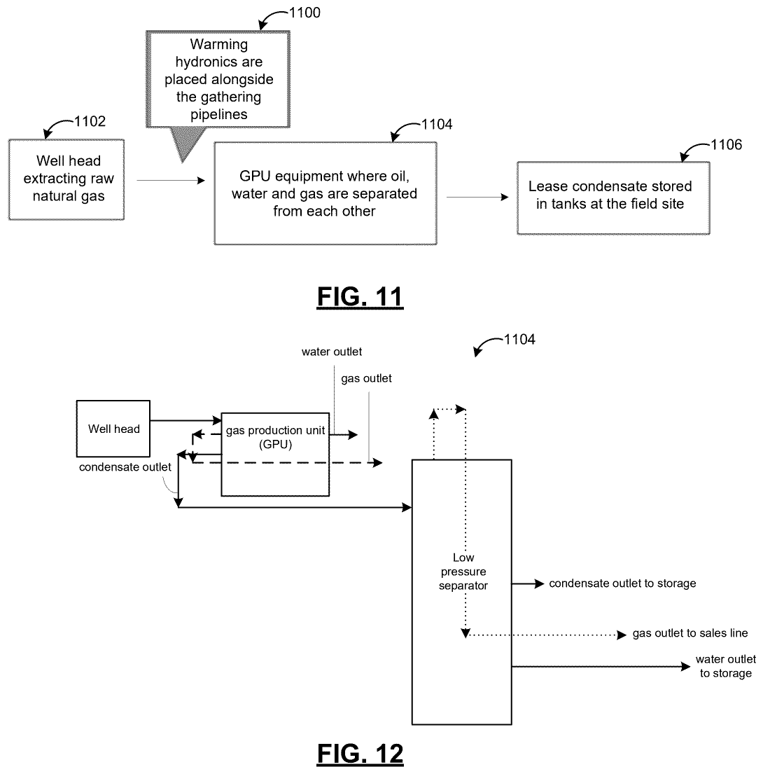

FIG. 11 shows a diagram of a placement of the systems, devices and methods, therein, warming hydronics 1100 are placed alongside gathering pipelines that carry natural gas from one or more well heads 1102 to separator equipment 1104. Downstream of the separator equipment 1104 is storage tanks 1106 for storing condensate from the separator equipment 1104. More specifically, the separator equipment 1104 may include a gas production unit and a low-pressure separator.

By warming, the systems, devices and methods described herein may inhibit the formation of liquid condensate in gathering pipelines carrying raw natural gas. Light hydrocarbons within the raw natural gas will condense in a gathering pipeline to a liquid state if the temperature falls below the hydrocarbon dew point. Condensate (a light oil liquid) settles out in low spots along the pipeline and reduces the effective pipeline bore, impairing flow rate. By warming the gathering pipelines carrying raw natural gas, the systems, devices and methods described herein warms the gas above the hydrocarbon dew point, preventing the formation of liquid condensate slugs in the gathering pipeline. This assures continual flow through the line.

Referring to FIG. 11, at the point of well head extraction from a gas condensate reservoir, raw natural gas is a mixture of hydrocarbon components in varying concentrations. Methane is the major component, along with amounts of heavier alkane hydrocarbons. The hydrocarbon dew point is the temperature at which the heavier alkane hydrocarbons (primarily ethane, propane and pentanes) begin to condense out of the gaseous phase as the raw natural gas is cooled.

A gathering pipeline leaking liquid condensate presents a danger of explosion and fire. Vapors can cause serious health effects if inhaled or swallowed. Industry workers operating in areas of a condensate leak from a pipeline are in danger from explosion, oxygen displacement (loss of balance) and asphyxiation.

Some hydrocarbons within the raw natural gas will condense to a liquid state if the temperature falls below the hydrocarbon dew point at a set pressure in a pipeline. Condensate can separate out of the raw natural gas stream gathering pipelines near the well head when the temperature and pressure of the gas is dropped to atmospheric ambient conditions.

Presently industry does not attempt to prevent the condensation of light hydrocarbons from the raw natural gas stream in gathering pipelines. First separation takes place at the production field site in gas processing equipment (called field separation, see FIG. 12). Industry then uses “liquid slug catchers” to mitigate large movements of liquids in the midstream pipelines transporting the natural gas from the well fields to gas processing plants downstream.

Condensation drop-out is a serious problem along the midstream transporting gas pipeline. Liquid condensate can arrive at the downstream gas processing plant as a very large liquid slug. Liquid condensate overflows at the gas processing plant can cause damage and facility shutdown.

The hydronic systems described herein may raise the temperature of the raw natural gas in the gathering pipelines above the hydrocarbon dew point, inhibiting the condensation of alkanes from their gas phase in the flow line. First condensation can then take place in the gas-oil-water separation processing equipment (FIG. 12). Working around gathering pipelines devoid of liquid condensate slugs would be safer for well site operation personnel. The danger posed by extremely flammable condensate to industry workers and pipeline equipment is reduced.

The cooling capability of the duel warming/cooling hydronics of the systems, devices and methods described herein would be useful at natural gas production facilities that produce and store “lease condensate” in tanks at the field site (FIG. 11). Lease condensate refers to light oil liquid recovered from raw natural gas in separator processing equipment on the leased field site before the natural gas production stream is piped to a natural gas processing facility downstream (FIG. 12). Condensates are used as a refinery feedstock. Natural gas liquids (ethane, ethylene, propane, butane, butylene, isobutene and isobutylene) are extracted from the delivered natural gas at the gas processing plants by fractionation methods of freezing and pressurizing.

FIG. 13 shows placement of the systems, devices and methods described herein to cool the lease condensate stored in tanks at the natural gas production field site. More specifically, therein, cooling hydronics 1300 are placed alongside industry pipelines transporting condensate from separator equipment 1304. Separator equipment 1304 is downstream from well heads 1302 extracting natural gas. Downstream of the separator equipment 1304 and the cooling hydronics 1300 is storage tanks 1306 for storing lease condensate from the separator equipment 1304.

Cooling industry pipelines carrying lease condensate to take storage may reduce the vapor pressure in the land-based storage tanks 1306 and lower the risk of explosion and fire.

### Example 6—Hydronic System Installed Upstream at Onshore Oil Well Sites and Natural Gas Well Sites Where Industry Facility Produced Water is Piped to Tank Storage

The warming capability of the systems, devices and methods described herein may also be useful upstream at crude oil production facilities and natural gas production facilities in geographic regions where cold winter weather increases the risk of pipeline blockage by ice in pipelines carrying industry facility produced water to tank storage at the field sites.

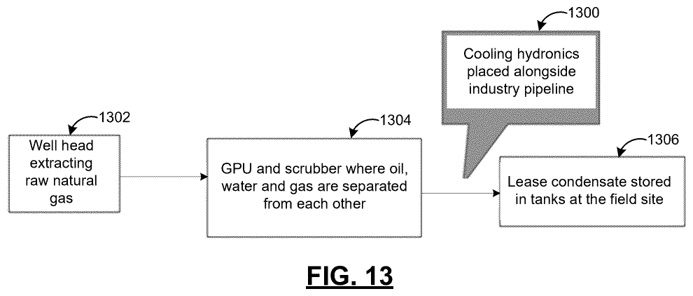

FIG. 14 shows a diagram of placement of the systems, devices and methods described herein at a crude oil production facility with pipelines carrying facility produced water to tank storage on the field site. More specifically, therein, warming hydronics 1400 are placed alongside pipelines transporting produced water from separator equipment 1404. Separator equipment 1404 is downstream from well heads 1402 extracting crude oil. Downstream of the separator equipment 1404 and the warming hydronics 1400 is tank 1406 for storing produced water from the separator equipment 1404.

By warming, the hydronic systems described herein may inhibit the formation of water ice in pipelines carrying produced water to tank storage. The risk of flow line expansion and rupture is reduced.

“Produced water” is brine water that is produced as a byproduct during the extraction of crude oil and natural gas from reservoirs. All produced water contains oil and suspended solids, and is considered an industrial waste. Offshore produced water undergoes primary treatment to separate out oil and is then discharged overboard. Onshore produced water undergoes primary treatment, and perhaps secondary and tertiary treatment depending on regulatory requirements. The produced water is stored in land-based tanks until treatment and disposal.

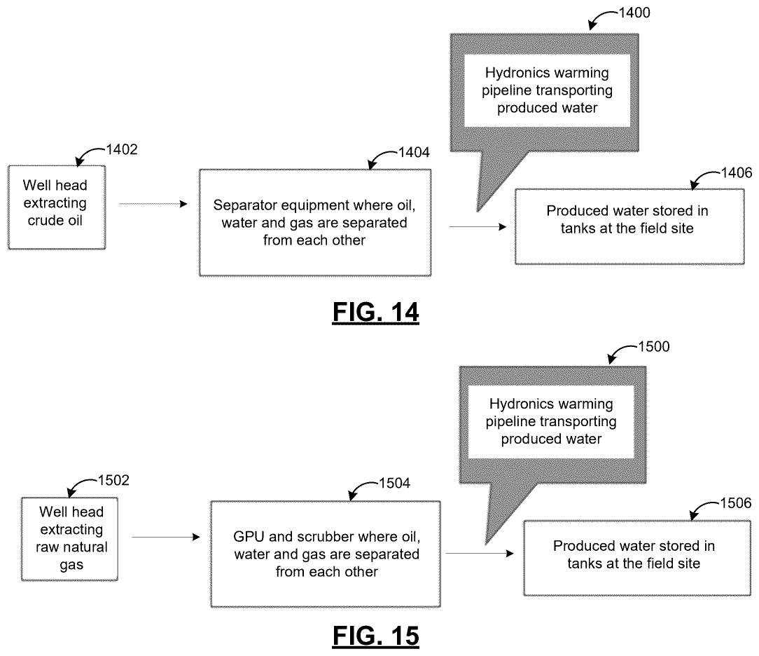

FIG. 15 shows a diagram of placement of the systems, devices and methods described herein at a natural gas production facility with pipelines carrying produced water to tank storage at the field site. More specifically, therein, warming hydronics 1500 are placed alongside pipelines transporting produced water from separator equipment 1504. Separator equipment 1504 is downstream from well heads 1502 extracting raw natural gas. Downstream of the separator equipment 1504 and the warming hydronics 1500 is storage tanks 1506 for storing produced water from the separator equipment 1504.

When the pressure of a gas changes, its temperature also changes. In natural gas production, when pressure is reduced across a control valve, the temperature of the gas is reduced (known as the Joule-Thompson effect). Because raw (untreated) natural gas has moisture in it, water ice can form in the pipeline and in valves if the temperature of the gas line drops below 0° C. (32° F.).

Extreme cold winter temperatures can result in the produced water becoming frozen and expanding in the flow line, which can block piping. Dead-legs, i.e., sections of piping connected to separator equipment without any flow are particularly vulnerable to the hazards of freezing. Produced water can freeze, expand and crack the dead-leg piping.

The U.S. Chemical Safety and Hazard Investigation Board recommends industry equipment that is susceptible to ice formation in cold weather should be identified through process hazard analysis and be winterized by “heat tracing.” Heat tracing is heat from fossil fuel burning applied to pipes, tanks, and equipment to inhibit ice from blocking flow.

The systems, devices and methods described herein may inhibit freezing by warming the pipeline carrying produced water to a temperature above ambient air freezing temperature. The hydronic system requires no energy input, other than the electricity needed to pump hydronic fluid (freshwater) through the hydronic system. Glycol could be added to the freshwater in the hydronic system described herein as an antifreeze agent in the hydronic fluid.

### Example 7—Hydronic System Installed Downstream at Petroleum Refineries and Petrochemical Plants That Store Flammable Liquids in Tanks

By cooling, the systems, devices and methods described herein may reduce the risk of explosion of flammable petroleum products produced at refineries and stored in tank farms and may reduce the risk of explosion of petrochemicals produced at chemical plants and stored in tank farms.

At refineries, petrochemical plants, and product storage terminals, the hydronic systems described herein are designed for cooling tanks storing flammable distillates and/or petrochemicals and may reduce vapor pressure and lower the risk of explosion and fire.

By cooling, the systems, devices and methods described herein may limit flammable vapor clouds in tanks, thereby reducing the risk of explosion and fire at tank storage terminals with systems for the distribution of industry products.

By cooling, the hydronic systems described herein may alter the flammability limit of volatile gases in petroleum distillate tanks and in petrochemical storage tanks, reducing the risk of explosion and fire.

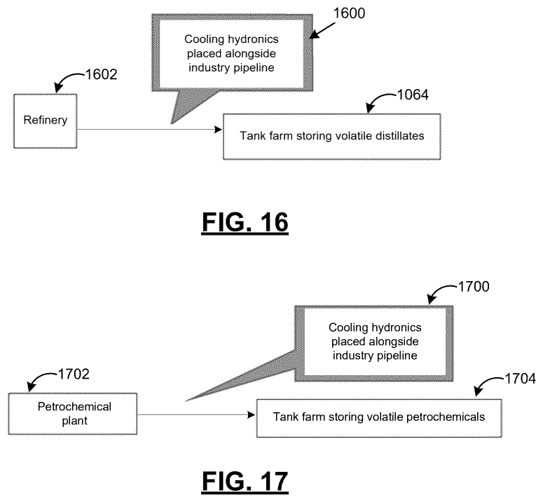

FIG. 16 shows placement of the systems, devices and methods described herein to reduce the risk of explosion of flammable petroleum products produced at refineries and stored in land-based tanks. More specifically, therein, cooling hydronics 1600 are placed alongside pipelines transporting volatile distillates from refinery 1602 to tank farm 1604.

Application of the systems is described herein to coastal refineries that produce flammable distillates. At coastal refineries, oil tankers offload oil of various API gravities to land-based storage tanks for processing. After processing by the refinery, the distillate products are transferred to other storage tanks until shipment to market, including petrochemical plants. Naphtha is a volatile distillate product of refineries used as input to petrochemical plants.

The pipe infrastructure at the landing pier at coastal refineries is similar to marine storage-transfer facilities, but there is additional piping from the refinery to the distillate storage tank farm.

For distillates (e.g. naphtha) produced at oil refineries and stored in domed fixed-roof tanks, the hydronic systems described herein may cool the flammable distillate, reducing the vapor pressure in the top of the storage tank, thereby limiting the explosive vapor cloud. By cooling, the systems, devices and methods described herein may reduce the probability of fire by reducing the mole fraction of hydrocarbon vapor in the vapor cloud mixture at the top of the distillate storage tank. The vapor cloud mixture in the tank is then below the flammability limit.

Management methods for inhibiting explosions involve refinery and petrochemical plant worker training and the “human awareness factor.” Current technologies that inhibit or mitigate incidents at refineries include critical alarms, pressure relief and venting systems, emergency isolation valves, and fire detection equipment. The hydronic systems described herein may add a new technological layer to the inhibition of explosions in petrochemical processing.

There is no standard practice that controls the temperature of stored distillate, keeping the vapor cloud mixture below the flammability limit. There is always a possibility of an explosion and fire where the ambient temperature is above the distillate's flash point.

For light distillates stored in domed tanks, it is not operationally practical to completely fill the tank, so there is a space left above the surface of the distillate. An explosive vapor cloud forms in this space of the tank.

The systems, devices and methods described herein can cool the flammable distillate pumped into the tank, reducing the vapor pressure in the top of the tank, thereby limiting the explosive vapor cloud.

The systems, devices and methods described herein may reduce the probability of fire by reducing the mole fraction of hydrocarbon vapor in the vapor cloud mixture at the top of the tank. The vapor cloud mixture in the tank is then below the flammability limit.

FIG. 17 shows placement of the systems, devices and methods described herein to reduce the risk of explosion of flammable petrochemicals produced at chemical plants and stored in land-based tanks. More specifically, therein, cooling hydronics 1700 may be placed alongside industry pipelines at petrochemical plant 1702 carrying volatile petrochemicals to tank farms 1704.

The systems, devices and methods described herein may cool the petrochemical in the storage tank below its lower flammable limit, inhibiting combustion. The lower flammable limit is the concentration of flammable vapor in the air above the petrochemical liquid in a storage tank sufficient to sustain combustion. The lower flammable limit is specific to each flammable petrochemical. Temperature determines the concentration of flammable vapor in the air at the top of the tank. The systems, devices and methods described herein decreases the temperature of the stored petrochemical, decreasing the vapor concentration.

The systems, devices and methods described herein may also provide freshwater for a firefighting capability at any facility where it is installed. The hydronic system utilizes a freshwater source near the industrial site for filling the hydronic piping. The hydronic system represents an on-site source of water when regional water for firefighting might be in limited supply.

For example, the fluid (freshwater) in the hydronic system can be sprayed by regional firefighters to cool the walls of tanks to keep them from catching fire from burning tanks nearby.

A water tower is an optional installation feature of the systems, devices and methods described herein that could be used to store freshwater taken from the freshwater source near the industrial site. The water tower would supply pressured freshwater to the hydronic system in the event of local electrical power failure for the water intake pump.

The hydronic fluid (freshwater) from the closed-loop heating/cooling system described herein can be used to fight Class A fires (involving solid combustible materials, e.g. wood, plastic).

Further, the freshwater from the hydronic systems described herein may also be used by regional firefighters to create foam to fight Class B fires (involving flammable petroleum products and petrochemicals).

### Results

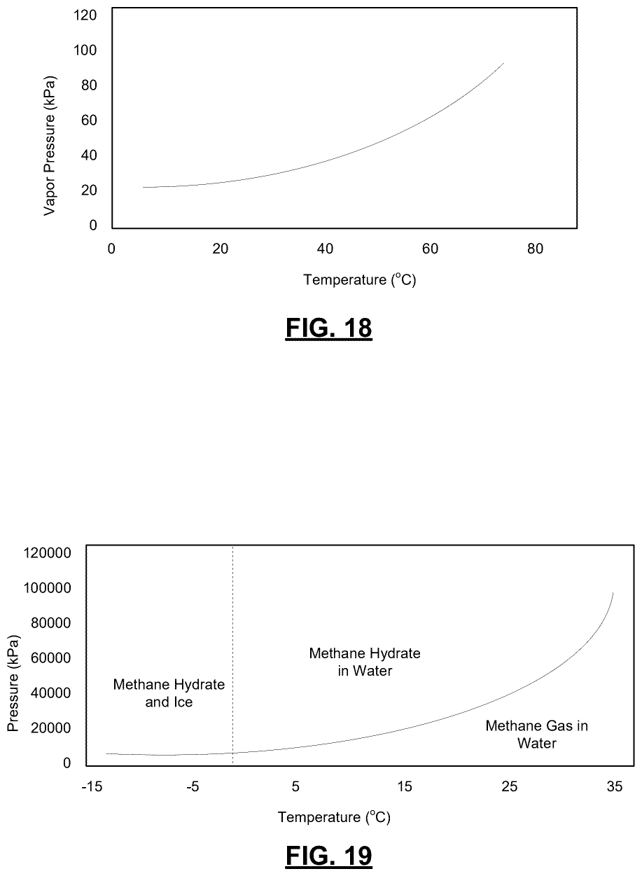

FIG. 18 shows temperature dependence of benzene vapor pressure. These data suggest that emission of benzene vapor fumes from a crude oil storage tank increases exponentially with rising temperature of the crude oil. Conversely, the emission of benzene vapor fumes from a storage tank decreases exponentially with cooler temperature of the crude oil. The tendency of methane (a potent GHG) and benzene (a neurotoxic VOC) to escape from crude oil stored in a tank is a function of the vapor pressure above the crude oil. The hydronic systems described herein may reduce the escape to the atmosphere of light hydrocarbons from the stored crude oil. The hydronic systems described herein can cool the crude oil pumped into the tank, reducing the vapor pressure in the top of the storage tank (for example as described in Example 1).

FIG. 19 shows that natural gas hydrates (ice-like solids) form when water and light natural gas components (e.g., methane) combine at high pressure and low temperature. Hydrates can block raw natural gas well gathering pipelines and natural gas processing equipment. By warming, the hydronic systems described herein may inhibit the formation of hydrates inside gathering pipelines carrying raw (untreated) natural gas, assuring continual flow through the line (for example as described above in Example 2).

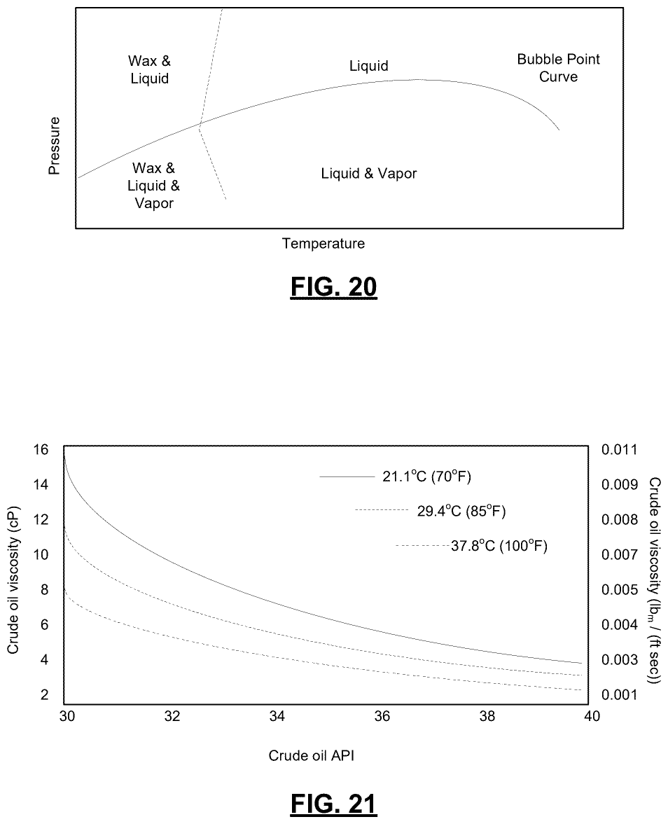

FIG. 20 shows the dependence of wax precipitation on temperature and pressure. Wax precipitation is strongly dependent on temperature and weakly dependent on pressure. The hydrocarbon composition of crude oil impacts wax deposition. Wax will deposit along the cold walls of a pipeline if the crude oil temperature is below the wax appearance temperature of 28° C.

There is heat loss to the environment from the crude oil produced at a well head as it flows through gathering pipelines. Wax builds up in the gathering pipeline with increasing distance from the oil well head. Paraffin waxes that have condensed on pipeline walls can restrict flow, resulting in back pressure. By warming, the hydronic systems described herein may inhibit the forming of a wax coating inside a gathering pipeline carrying heavy crude oil. The result is maintenance of flow of the heavy crude oil through industry pipelines (for example as described above in Example 3).

FIG. 21 shows the temperature dependence of the viscosity of crude oils over a range of API gravities. Lighter grades of oil have higher values of API gravity. Crude oil flows through pipelines more easily with warmer ambient temperature, and less easily at colder ambient temperature. Cold weather temperatures would increase the viscosity of the crude in the pipeline. The force of pumping would need to be increased. The hydronic systems described herein may warm heavy crude oil and extra-heavy crude oil, maintaining the oil's viscosity and its flow through industry pipelines (for example as described above in Example 4).

FIG. 22 shows a phase envelope for three stages of natural gas. Hydrocarbon dew point (HCDP) indicates the temperature at which hydrocarbon components begin to condense out of the gaseous phase when the natural gas is cooled at constant pressure. By warming, the hydronic systems described herein may inhibit the formation of a liquid condensate slug inside a gathering pipeline carrying raw (untreated) natural gas from a wellhead. The hydronic systems described herein may raise the temperature of the raw natural gas in the gathering pipelines above the hydrocarbon dew point (HCDP). This inhibits the condensation of ethane, propane and pentanes from their gas phase in the flow line. The danger posed by extremely flammable liquid condensate to industry workers and pipeline equipment is reduced (for example as described above in Example 5).

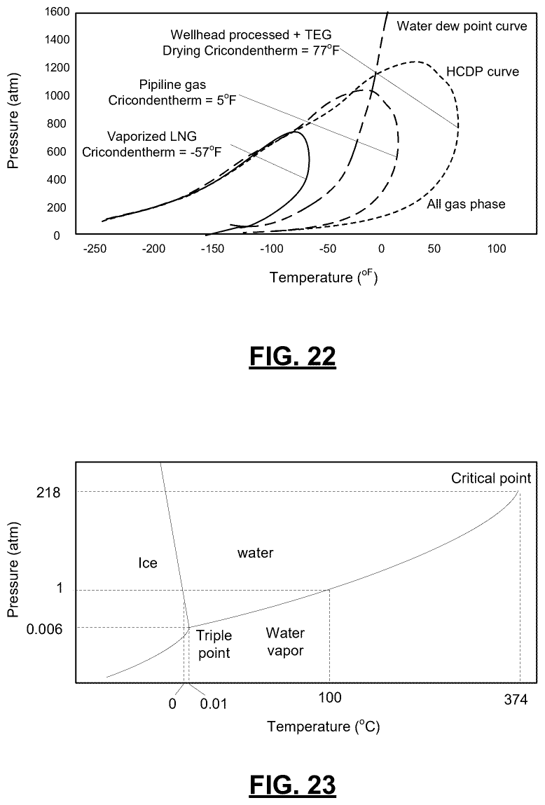

FIG. 23 shows a phase envelope for water with temperature and pressure. By warming, the hydronic systems described herein may inhibit the freezing of water inside a pipeline carrying industry facility produced water. The risk of flow line blockage is reduced. The hydronic systems described herein maintains optimal pipeline operations during severely cold weather events (for example as described above in Example 6).

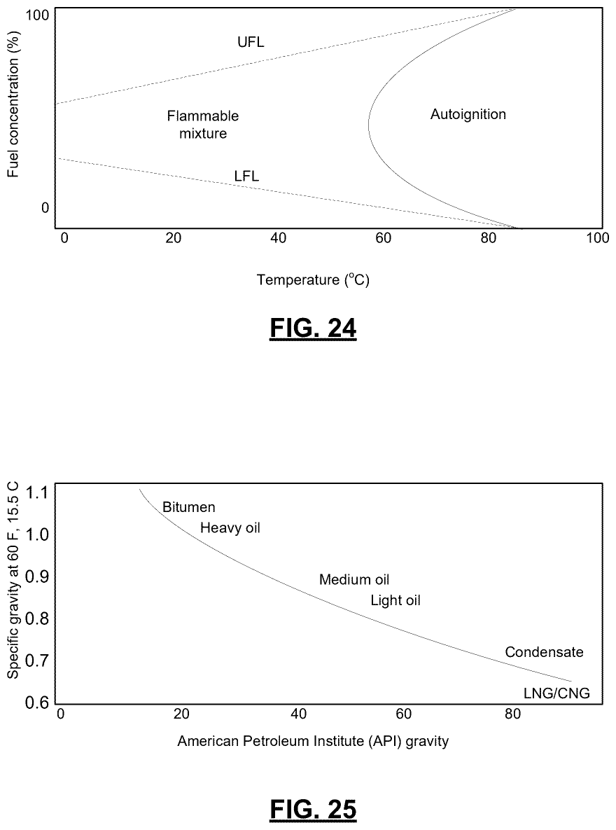

FIG. 24 shows a flammable mixture of vapor and air as a function of temperature. The lower flammable limit (LFL) is a fire safety concept. The LFL is the lower end of the concentration range over which a flammable mixture of vapor and air can be ignited at a given temperature and pressure. The flammability range is between the upper flammability limit (UFL) and lower flammability limit (LFL). Outside of this range, the air with vapor mixture cannot be ignited, unless the temperature and pressure are increased.

By cooling, the hydronic systems described herein may reduce the probability of explosion and fire by reducing the mole fraction of hydrocarbon vapor in the vapor cloud mixture at the top of a petroleum distillate storage tank or petrochemical storage tank. The vapor cloud mixture in the tank is then below the flammability limit (for example as described above in Example 7).

### Glossary

Herein, alkane, or paraffin, means an acyclic saturated hydrocarbon. An alkane consists of hydrogen and carbon atoms arranged in a structure where all the carbon-carbon bonds are single. Alkanes have the general chemical formula CₙH₂ₙ₊₂. The simplest alkane, methane is CH₄. Ethane is C₂H₆. Propane is C₃H₈. Butane is C₄H₁₀. Pentane is C₅H₁₂. Hexane is C₆H₁₄. Heptane is C₇H₁₆. Octane is C₈H₁₈.

Herein, American Petroleum Institute (API) gravity means a standard measure of how heavy or light a petroleum liquid is compared to water. API gravity data are collected from initial tests of oil and gas development wells. The lighter the crude oil, the higher the API gravity. The API gravity measure is used in crude oil trading and pricing.

FIG. 25 shows a graph showing API gravity versus specific gravity. The specific gravity of pure water at 60° F. (15.5° C.) is 1.0 (density of 1000 kg/m³). Extra heavy oil with a specific gravity of 1.0 has an API gravity of 10°. Lighter grades of oil have higher values of API gravity. If a petroleum liquid has an API gravity greater than 10°, it floats on water.

The boiling point is the temperature at which the vapor pressure of the petroleum liquid equals the external pressure surrounding the petroleum liquid. Boiling points of organic compounds increase as the number of carbon atoms in the molecular formula increase. (Note: Water boils at the temperature where the vapor pressure of the water liquid equals the atmospheric pressure).

Clean technology refers to any process, product or service that optimizes the use of natural resources, while reducing the negative impacts that industries have on the earth ecosystems through improvement in operations.

In the oil industry, the cloud point is the temperature below which wax forms in the oil giving a cloudy appearance. The wax thickens the oil and accumulates on cold surfaces inside a pipeline. For crude oil, cloud point is synonymous with wax precipitation temperature.

Condensate is a light oil liquid with an API gravity of 45° to 70°. There are many sources of condensate, including crude oil wells, dry gas wells and condensate wells. Condensate is often used to dilute heavier oils for transport via pipelines.

Unconventional oil is petroleum produced from geological formations using techniques other than the conventional oil well extraction method (i.e. drilling vertically down to sandstone and retrieving the resource). Conventional oil includes crude oil, natural gas and its condensates. Unconventional oil includes oil sands bitumen, extra heavy oil and shale oil. Unconventional technologies for production from bituminous deposits include steam-assisted gravity drainage and surface mining.

Petroleum distillate refers to any mixture of volatile organic carbons (VOCs) produced by condensing vapors of petroleum during distillation at a refinery. Light distillates are methane, ethane, propane, and butane. Fuels produced are gasoline, kerosene, jet fuel, diesel, heating oil, industrial gasoil and marine gasoil. Naphtha produced becomes a feedstock for petrochemical plants where naphtha can be cracked into ethene, propene, butene and polymers for creating plastics. Distillation residues include heavy fuel oil, bitumen, asphalt, lubricating oil and waxes.

Downstream oil and natural gas operations refers to natural gas processing facilities, oil refineries, petrochemical plants, liquid natural gas (LNG) facilities and storage terminals with systems for the distribution of industry products.

The fire point is the lowest temperature at which the flammable vapor of a petrochemical will continue to burn after ignition. The vapor in the air above the petrochemical liquid in a storage tank is produced at a rate to sustain the fire. Temperature determines the concentration of vapor in the air above the petrochemical liquid in the tank.

A combustible material (solid, liquid or gas) is flammable if it ignites easily at ambient temperature, causing fires or an explosion. The degree of flammability depends upon the volatility of the material. Volatility is related to its vapor pressure, which is temperature dependent.

Any petrochemical with a flash point less than 100° F. (37.8° C.) is defined as flammable. The flash point is the lowest temperature at which that the petrochemical produces vapor at a rate sufficient to form an ignitable mixture with air above the petrochemical liquid in the storage tank. The hazard of a flammable petrochemical increases as the flash point decreases. The flash point temperature is specific to that volatile hydrocarbon.

The flash point is the lowest temperature at which there is enough flammable vapor in the air above the petrochemical liquid in a storage tank to induce ignition when an ignition source is present. It should be noted that ignition source temperature is much higher than either the flash point or fire point. The fire point is the lowest temperature at which the vapors keep burning. The fire point temperature is higher than the flash point temperature, because at the lower temperature of the flash point not enough vapor may be produced to sustain combustion.

Flashing losses occur when a petroleum liquid under pressure is pumped into a storage tank at atmospheric pressure. As the pressure drops, vapors boil out of the petroleum liquid until a new equilibrium is reached. Flashing losses occur during upstream oil production operations, when oil and gas is pumped out of the ground under pressure and into a storage tank at atmospheric pressure, whereupon natural gas “boils off.” Flashing losses also occur during downstream petroleum processing refinery operations, where a distillate under pressure is stored in a fixed-roof tank at atmospheric pressure. Vapors will bubble (i.e. boil) out of solution to the top of the tank and into the atmosphere through the tank vent.

Fugitive emissions are light hydrocarbons that escape to the atmosphere from oil and gas production wells, from oil and gas in pressurized pipelines, and from oil storage tanks. In addition to the economic cost of lost hydrocarbons, fugitive emissions are air pollutants. Escaping hydrocarbons include methane, which is a potent greenhouse gas (GHG), and benzene, which is a carcinogenic and neurotoxic volatile organic compound (VOC).

Gel point is the temperature at which an oil freezes and can no longer flow by gravity or be pumped through a pipeline. Enough wax crystals have formed to inhibit any movement in the oil. For the oil to be pumped again, it must be warmed above the gel point temperature. However, the wax will remain until the oil is warmed up further to re-dissolve the wax crystals.

Greenhouse gases are constituents of the atmosphere that absorb and emit radiation at specific wavelengths that causes the greenhouse effect. Water vapor (H₂O), carbon dioxide (CO₂), nitrous oxide (N₂O), methane (CH₄) and ozone (O₂) are the primary greenhouse gases.

Heat capacity is the amount of heat that must be added to or removed from a substance, to change its temperature. Because oil has a lower heat capacity than water, the temperature of light crude oil and medium heavy crude oil can be lowered by the cooling fluid (water) hydronic system. Similarly, the temperature of heavy crude oil and extra-heavy crude oil can be raised by the warming fluid (freshwater) hydronic system.

Heavy crude oil is highly viscous and has an API gravity between 10° and 22.3°. Extra-heavy crude oil has an API gravity<10° (heavier than water). The dense and viscous character of heavy crude oil is due to the higher percentage of hydrocarbons with over 60 carbon atoms per molecule, hence a high boiling point. Heavy oil typically has little paraffin and a low proportion of volatile, low molecular weight hydrocarbons. Bitumen from oil sands is the heaviest, thickest form of petroleum. A diluent (usually condensate) is blended with bitumen for pumping through pipelines. A diluent is added at regular distances in a pipeline to facilitate flow.

Natural infrastructure is the atmosphere, land, freshwater bodies, coastal seas and open oceans that provide ecosystem services for human health and wellbeing. Hybrid natural infrastructure is the combination of human-built infrastructure with natural infrastructure, e.g. a reservoir with hydropower dam, solar power facility, wind power facility, and tidal power facility.

Methane clathrates (also called hydrates) are white, ice-like solids that form when liquid water in raw (untreated) natural gas interacts with light hydrocarbons in the natural gas. Hydrates are formed during natural gas production operations when water is condensed in the presence of methane. Hydrates may form and block pipelines and processing equipment at ambient temperatures (<38° C., 100° F.) and moderate pressures (>180 psia).

Hydrocarbon dew point (HDP) is the temperature (at a given pressure) at which the heavier alkane hydrocarbon components of natural gas will start to condense out of the gaseous phase when the gas is cooled under pressure. If the natural gas contains a high proportion of heavy alkane hydrocarbons, there is a greater risk of liquid condensate forming in the pipeline.

A hydronic system is a cooling or warming system in which heat is transported using circulating water in a closed system of pipes.

In thermodynamics, the Joule-Thomson effect describes the temperature change of a gas or liquid when it is forced through a valve. The gas becomes cooler when it is allowed to expand.

Lease condensate refers to liquid light hydrocarbons (primarily ethane, propane and pentanes) recovered from raw natural gas by separator equipment on the leased field facilities before the gas stream is piped to a downstream natural gas processing facility. Some of the light hydrocarbons within the raw natural gas will condense in a gathering pipeline into a liquid condensate slug if the temperature falls below the hydrocarbon dew point.

Hydrocarbons with low molecular weight, such as ethane, propane and butane are termed light hydrocarbons. The API gravity of crude oil increases with composition of light hydrocarbons. Light crude oil has an API gravity>31.1°.

“Low carbon” refers to activities that release less carbon dioxide to the atmosphere. Carbon dioxide is a greenhouse gas that drives global warming.

The lower flammable limit is the concentration of flammable vapor in the air above the petrochemical liquid in a storage tank sufficient to sustain combustion. The lower flammable limit is specific to each flammable petrochemical. Temperature determines the concentration of flammable vapor in the air at the top of the tank. As temperature decreases, vapor concentration decreases.

Medium crude is more viscous than light crude oil. Medium crude has an API gravity between 22.3° and 31.1° with medium light hydrocarbon fractions.

Midstream activities include the storing and transporting of produced oil, natural gas, and condensate. Systems for the transportation of oil and gas include pipelines, ocean-going tanker ships, and trains.

Natural gas is a mixture of methane and various amounts of heavier alkanes. Natural gas that is extracted along with crude oil from oil wells is called associated gas. Non-associated gas is extracted directly from natural gas fields. Unconventional gas is extracted from gas-rich shale rock formations using hydraulic fracturing or “fracking” techniques.

Natural gas liquids (ethane, ethylene, propane, butane, butylene, isobutene and isobutylene) are extracted from natural gas at downstream gas processing plants by fractionation methods of freezing and pressurizing.

Petrochemical products include any aromatic, olefin, and synthesis gas, and any of their derivatives, including ethylene, propylene, butadiene, benzene, toluene, xylene, ammonia, methanol, and urea. In keeping with the U.S. Energy Information Administration definition, petroleum products do not include natural gas, liquefied natural gas, biofuels, methanol, and other nonpetroleum fuels.

Paraffin is the alkane components of petroleum and natural gas. Alkanes with fewer than five carbon atoms per molecule are gases at room temperature. Alkanes with 5-15 carbon atoms are fluid. Straight-chain alkanes with more than 15 carbon atoms per molecule are solid at room temperature. Paraffin waxes that have condensed on pipeline walls can restrict flow, resulting in back pressure.

The pour point is the temperature below which oil loses its flow characteristics.

Raw natural gas means natural gas produced at the casing head of a natural gas well, condensate well or crude oil well. Raw natural gas from production wells contains hydrocarbons, carbon dioxide, hydrogen sulfide, nitrogen, water, and other impurities. Raw natural gas must be purified in gas processing plants into finished by-products, such as natural gas liquids (NGLs).

“Renewable energy” refers to energy derived from natural sources that are replenished at a higher rate than they are consumed.

Standing petroleum tank “breathing loss” occurs in fixed-roof tanks when daily solar warming of the storage tank causes vapor pressure in the top of the tank to increase, resulting in vapors escaping out of the tank vent. For floating-roof tanks, vapors escape past the rim seals, deck fittings and deck seams.

Movement of petroleum liquid through storage tanks causes working losses, i.e. release of fugitive emissions. Filling a fixed-roof tank with incoming petroleum liquid displaces vapors existing in the tank out through the vent at the top of the tank. Emptying a floating-roof tank leaves behind oil clinging to the tank walls from which there are vapors.

Upstream crude oil and natural gas production operations refers to installations both on land and offshore.

The vapor pressure of a liquid in a closed container is the point at which the equilibrium pressure is reached between molecules leaving the liquid (going into the gaseous phase) and molecules leaving the gaseous phase (entering the liquid phase). Vapor pressure is non-linearly dependent on temperature. A substance with a high vapor pressure at ambient temperature is called volatile.

Viscosity and wax content are properties of crude oil important to its transportation and refining. Oil viscosity is the measure of the oil's resistance to flow. It depends on the oil's temperature and pressure. When oil is pumped through a pipeline, it flows more quickly near the pipe's axis than near the pipe walls. A pressure difference between the two ends of the pipeline is needed to sustain the flow. The needed pressure is proportional to the oil's viscosity.

Volatile organic compounds (VOCs) are organic chemicals that have a high vapor pressure at room temperatures of 20-22° C. (68-72° F.). High vapor pressure correlates with a low boiling point. Some VOCs can affect air quality and be dangerous to human health. Most VOCs are not acutely toxic, but may have long-term chronic health effects.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

What is claimed is:

1. A closed loop, hydronic system configured to control a temperature of a petroleum at an upstream petroleum production facility, the system comprising
a first heat exchanger submerged in a body of water at a first depth; and
hydronic pipeline infrastructure fluidly connected to the first heat exchanger and positioned along and adjacent to at least a portion of a vessel containing the petroleum,
wherein
the hydronic pipeline infrastructure is configured to receive fluid from the first heat exchanger, the fluid being at a first temperature that is below an initial temperature of the petroleum, the fluid within the hydronic pipeline infrastructure receiving heat from the petroleum as the fluid within the hydronic pipeline infrastructure passes by the petroleum to reduce a temperature of the petroleum.

2. The system of claim 1 further comprising a second heat exchanger submerged in the body of water at a second depth, the hydronic pipeline infrastructure also being fluidly connected to the second heat exchanger, the hydronic pipeline infrastructure being configured to receive fluid from the second heat exchanger at a second temperature that is above the initial temperature of the petroleum, the fluid within the hydronic pipeline infrastructure providing heat from the fluid to the petroleum as the fluid within the hydronic pipeline infrastructure passes by the petroleum.

3. The system of claim 1, wherein the vessel is a crude oil transfer pipe and the petroleum is crude oil.

4. The system of claim 1, wherein the vessel is a raw natural gas transfer pipe and the petroleum is natural gas.

5. The system of claim 1, wherein the vessel is a well extracting natural gas and the petroleum is the natural gas.

6. The system of claim 1, wherein the vessel is a storage tank and the petroleum is natural gas.

7. The system of claim 1, wherein the vessel is a storage tank and the petroleum is crude oil.

8. The system of claim 1, wherein the hydronic pipeline infrastructure surrounds the vessel.

9. The system of claim 1, further comprising a covering configured to surround the hydronic pipeline infrastructure and the vessel.

10. A closed loop, hydronic system configured to control a temperature of a petroleum at a midstream distribution terminal or transfer facility, the system comprising:
a first heat exchanger submerged in a body of water at a first depth; and
hydronic pipeline infrastructure fluidly connected to the first heat exchanger and positioned along and adjacent to at least a portion of a vessel containing the petroleum,
wherein
the hydronic pipeline infrastructure is configured to receive fluid from the first heat exchanger, the fluid being at a first temperature that is below an initial temperature of the petroleum, the fluid within the hydronic pipeline infrastructure receiving heat from the petroleum as the fluid within the hydronic pipeline infrastructure passes by the petroleum to reduce a temperature of the petroleum.

11. The system of claim 10 further comprising a second heat exchanger submerged in the body of water at a second depth, the hydronic pipeline infrastructure also being fluidly connected to the second heat exchanger, the hydronic pipeline infrastructure being configured to receive fluid from the second heat exchanger at a second temperature that is above the initial temperature of the petroleum, the fluid within the hydronic pipeline infrastructure providing heat from the fluid to the petroleum as the fluid within the hydronic pipeline infrastructure passes by the petroleum.

12. The system of claim 10, wherein the vessel is a storage tank and the petroleum is heavy crude oil or extra heavy crude oil.

13. The system of claim 10, wherein the vessel is a transfer pipe and the petroleum is heavy crude oil or extra heavy crude oil.

14. The system of claim 10, wherein the hydronic pipeline infrastructure surrounds the vessel.

15. The system of claim 10, further comprising a covering configured to surround the hydronic pipeline infrastructure and the vessel.

16. A closed loop, hydronic system configured to control a temperature of flammable petroleum products produced at refineries and stored in tank farms, the system comprising
a first heat exchanger submerged in a body of water at a first depth; and
hydronic pipeline infrastructure fluidly connected to the first heat exchanger and positioned along and adjacent to at least a portion of a vessel containing the petroleum,
wherein
the hydronic pipeline infrastructure is configured to receive fluid from the first heat exchanger, the fluid being at a first temperature that is below an initial temperature of the petroleum, the fluid within the hydronic pipeline infrastructure receiving heat from the petroleum as the fluid within the hydronic pipeline infrastructure passes by the petroleum to reduce a temperature of the petroleum.

17. The system of claim 16, wherein the hydronic pipeline infrastructure cools flammable distillate pumped into the vessel, reducing vapor pressure in the top of the vessel, thereby limiting explosive vapor cloud.

18. The system of claim 16, wherein the vessel is a storage tank and the petroleum is naphtha.

19. The system of claim 16, wherein the hydronic pipeline infrastructure surrounds the vessel.

20. The system of claim 16 further comprising a water tower configured to store freshwater and supply pressured freshwater to the hydronic pipeline infrastructure.
